(19) United States
(12) Patent Application Publication
(10) Pub. No.: US 2016/0197831 A1
(43) Pub. Date: Jul. 7, 2016

(54) METHOD AND APPARATUS FOR NAME RESOLUTION IN SOFTWARE DEFINED NETWORKING

(71) Applicant: InterDigital Patent Holdings, Inc., Wilmington, DE (US)

(72) Inventors: Xavier DE FOY, Montreal (CA); Hang Liu, North Potomac, MD (US); Hao Jin, King of Prussia, PA (US)

(73) Assignee: InterDigital Patent Holdings, Inc., Wilimington, DE (US)

(21) Appl. No.: 14/911,600

(22) PCT Filed: Aug. 8, 2014
(86) PCT No.: PCT/US14/50363

§ 371 Date: Feb. 11, 2016

Related U.S. Application Data
(60) Provisional application No. 61/866,579, filed on Aug. 16, 2013.
(60) Provisional application No. 61/969,566, filed on Mar. 24, 2014.

(51) Int. Cl. H04L 12/743; H04L 12/721

(52) U.S. Cl. CPC H04L 45/7453; H04L 45/566

(57) ABSTRACT

This disclosure relates enhancements to a SDN system including the controller, southbound interface, and OpenFlow devices, to enable hash-routing, and describes SDN applications making use of this feature. More specifically, the application relates to Software Defined Networking (e.g., OpenFlow) enhancements to facilitate the deployment and usage of Distributed Hash Tables, for example as part of Information Centric Networking (ICN).

### RELATED APPLICATIONS

This application takes priority of U.S. Provisional Patent Application No. 61/969,566 and U.S. Provisional Patent Application No. 61/866,579, the contents of which are incorporated as if fully set forth herein.

### FIELD OF THE INVENTION

This application relates to enhancements for a SDN (Software Defined Network) system to enable hash-routing. More specifically, the application relates to Software Defined Networking (e.g., OpenFlow) and the deployment and usage of Distributed Hash Tables, for example, as part of Information Centric Networking (ICN).

### BACKGROUND

Multiple ICN solutions have been designed, including DONA, CCN, PubSub, and Netlnf, which are reviewed in [1], as well as CONET [2].

### SUMMARY

The present application pertains to methods and apparatus for enhancing SDNs, such as OpenFlow networks, to facilitate the deployment and usage of Distributed Hash Tables (DHTs), for example as part of Information Centric Networking (ICN).

According to a first aspect, the present invention pertains to methods and apparatus for creating a Distributed Hash Table (DHT) among a plurality of DHT nodes in a Software Defined Networking (SDN) domain comprising a DHT Control Plane (DHTCP) module adapted to manage a plurality of DHT nodes to maintain a DHT, the DHTCP comprising a processor adapted to receive messages from DHT nodes indicating status of the DHT nodes, including joining and leaving the DHT, determine a range-based distribution among the DHT nodes of (key, value) pairs of a DHT as a function of the keys of the (key, value) pairs, and send configuration messages to the DHT nodes for configuring each DHT node to store at least one range of keys corresponding to ((key, value)) pairs of said DHT.

According to another aspect, the present application pertains to a method and apparatus for handling Distributed Hash Table (DHT) routing requests in a Software Defined Networking (SDN) domain comprising a plurality of SDN switches interconnecting a plurality of DHT nodes, each DHT node containing a portion of a DHT, the method and/or apparatus comprising receiving at a first one of the DHT nodes a Publish request corresponding to a content object, the Publish request including a (key, value) pair, where the key corresponds to a content ID and the value is the location where the content object is stored, if the key in the Publish request is in a portion of the DHT not contained at the first DHT node, the first DHT node forwarding the Publish request to a first one of the SDN switches, the first SDN switch including a forwarding table in which ranges of keys of (key, value) pairs are mapped to DHT nodes, and the first SDN switch matching the key from the Publish request with one of the key ranges in the forwarding table and forwarding the Publish request toward a second DHT node, the second DHT node being the DHT node to which the key of the ((key, value)) pair in the Publish request maps, and the second DHT node receiving the Publish request and storing the (key, value) pair found in the Publish request in its DHT portion.

According to another aspect, the present application pertains to a method and apparatus for processing Distributed Hash Table (DHT) routing requests in a Software Defined Networking (SDN) domain comprising a plurality of SDN switches interconnecting a plurality of DHT nodes, each DHT node containing a portion of a DHT, the method and/or apparatus comprising receiving at a first one of the DHT nodes a Subscribe request for a content object, the Subscribe request including a key, where the key corresponds to a content ID, if the key in the Subscribe request does not match a key in the portion of the DHT of the first DHT node, the first DHT node forwarding the Subscribe request to a first one of the SDN switches, and the first SDN switch including a forwarding table in which ranges of keys corresponding to (key, value) pairs are mapped to DHT nodes, the first SDN switch matching the key from the Subscribe request with one of the key ranges in the forwarding table, and forwarding the Subscribe request toward a second DHT node, the second DHT node being the DHT node to which the key of the ((key, value)) pair in the Subscribe request maps.

According to another aspect, the present application pertains to a method and apparatus implemented in a Software Defined Networking (SDN) switch/router comprising transmitting to an SDN controller a message including Hash Routing Control (HRC) capabilities of the switch/router, and receiving from the SDN controller a message including at least one hash routing descriptor indicating how the switch/router is to process routing requests.

According to another aspect, the present application pertains to a method and apparatus implemented in a Software Defined Networking (SDN) switch/router comprising maintaining a flow table for routing data packets in a SDN network, receiving from an SDN controller a flow table modification message defining a change to the flow table maintained at the switch/router, wherein the flow entry modification message further includes at least one of (1) an information element (IE) specifying a method for extracting hash function inputs from the data packets, (2) an IE specifying how a hash function is calculated from the hash function inputs, and (3) an IE specifying a range of hash function outputs to which the flow entry applies, and updating the flow table using the IEs in the flow entry modification message.

According to another aspect, the present application pertains to a method and apparatus implemented in a Software Defined Networking (SDN) controller for configuring an SDN network for Hash Routing Control (HRC) comprising transmitting a features request message to a SDN switch/router requesting information disclosing hash routing control (HRC) features of the switch/router, and receiving in response to the features request a features reply message, the features response message including an HRC information element (IE) disclosing the HRC capabilities of the switch/router.

According to another aspect, the present application pertains to a method and apparatus implemented in a Software Defined Networking (SDN) switch/router comprising maintaining a first flow table for routing data packets in a SDN network, maintaining a second flow table for routing the data packets according to a Hash Routing control (HRC), receiving from an SDN controller a flow table modification message defining a change to one of the first and second flow tables, the flow table modification message identifying a hash function and identifying a condition applicable to a hash value calculated using the hash function, and updating the first or second flow table according to the flow entry modification message.

According to another aspect, the present application pertains to a method and apparatus method implemented in a Software Defined Networking (SDN) controller comprising transmitting a flow table modification message to a SDN switch/router, wherein the flow table modification message defines a change to a flow table, identifies a hash function, and identifies a condition applicable to a hash value calculated using the hash function.

### BRIEF DESCRIPTION OF THE DRAWINGS

A more detailed understanding may be had from the following description, given by way of example in conjunction with the accompanying drawings wherein:

FIG. 1 is a block diagram illustrating the main entities in a typical OpenFlow SDN network;

FIG. 2 is a block diagram illustrating the parallels between an SDN stack and an operating system;

FIG. 3 is a block diagram of an SND controlled ICN network showing signal flow in accordance with one embodiment;

FIG. 4A illustrates a network stack for an exemplary implementation of Distributed Hash Table Control Protocol (DHTCP) as a separate entity.

FIG. 4B illustrates a network stack for an exemplary implementation of DHTCP as a part of the SDN Controller stack. ;

FIG. 5 is an exemplary Distributed Hash Table (DHT) Key-range routing table;

FIG. 6 is a block diagram of an SDN-controlled ICN network showing signal flow for DHT maintenance in accordance with an exemplary embodiment;

FIG. 7 is a block diagram of an SDN-controlled ICN network showing signal flow for DHT maintenance in accordance with an exemplary embodiment;

FIG. 8 is a block diagram of an SDN-controlled ICN network showing signal flow for content subscription in accordance with an exemplary embodiment;

FIG. 9 is a block diagram of an SDN-controlled ICN network illustrating signal flow using a DHT-based Name Resolution System (NRS) distinct from the content router infrastructure in accordance with an exemplary embodiment;

FIG. 10 is a block diagram of an SDN-enhanced ICN network with overlay DHT message routing in accordance with an exemplary embodiment;

FIG. 11 is a block diagram showing a network comprising a plurality of cooperating SDN domains that uses a multi-domain SDN-enabled DHT in accordance with an exemplary embodiment;

FIG. 12 is a block diagram of a Hash-Routing aware SDN stack according to an exemplary embodiment;

FIG. 13A is a flow diagram illustrating conventional packet processing through an OpenFlow switch;

FIGS. 13B and 13C is a flow diagram illustrating packet processing through an OpenFlow switch in accordance with an exemplary embodiment;

FIG. 14 shows an exemplary network topology in which an embodiment may be implemented;

FIGS. 15A and 15B collectively illustrate Hash-routing control message flow in accordance with an exemplary embodiment;

FIGS. 16A and 16B collectively illustrate Hash-routing control message flow in accordance with another exemplary embodiment;

FIG. 17A is a system diagram of an example communications system in which one or more disclosed embodiments may be implemented;

FIG. 17B is a system diagram of an example wireless transmit/receive unit (WTRU) that may be used within the communications system illustrated in FIG. 17A; and,

FIGS. 17C-17E are system diagrams of an example radio access networks and example core networks that may be used within the communications system illustrated in FIG. 17A.

### DETAILED DESCRIPTION

### 1 INFORMATION CENTRIC NETWORKING (ICN)

The ICN design in [3] is based on a Scalable Multi-level Virtual Distributed Hash Table (SMVDHT). SMVDHT enables name resolution and routing. Every routing area, domain, and Autonomous System (AS) deploys a DHT formed with content routers. These DHTs are connected in a hierarchical fashion to form the SMVDHT. SMVDHT is used to store a storage location associated with a given content ID. This information is advertised to upper layer DHTs in an aggregated form. In content requests and responses, an Object ID (OID) is present as a shim layer between the IP layer and transport headers. When a content request reaches a content router, the content router queries the SMVDHT for the location of the object (or the next hop toward this location). Each DHT may individually be inside a single domain (which may or may not be an SDN-controlled domain).

NetInf[4] supports a range of name-based and name-resolution-based object retrieval methods. Name resolution systems that are considered in the Netlnf architecture include Multilevel DHT (MDHT) [5], which is composed of several entangled DHTs. A given DHT node may belong to one or several DHTs which are handling different scopes, ranging from local area networks to a global internetwork scope. Some of these DHTs typically are inside a single domain, while some other of these DHTs typically are more global and span several domains.

### 2 DHTS

2.1 General Overview

Structured overlay networks place assumptions on how nodes are organized in a distributed environment and emphasize decentralization, scalability, and fault tolerance. They are based on the notion of a semantic-free index identifying nodes (peers) as well as data objects (e.g., the index for data objects may be obtained from hashing that object). Keys and nodes share the same identifier space, which makes it possible for the distributed system to map a key to a particular node where the (key, value) pair (i.e., the previously mentioned key and its associated data object) is to be stored. Each peer maintains a routing table (e.g., node IDs and IP addresses) of a set of neighbors, which enables the routing of insertion, lookup, and removal messages to their final destination in one or more hops.

Structured overlay networks may be deployed inside a single administrative domain or in a wide area network. Cluster-type deployments can focus on limiting the number of hops to reach the destination node (in one extreme case there may be 1-hop DHTs, for example), while systems designed for wide area network deployment need to balance hop count with other characteristics like the size of the routing table, network diameter (i.e., the “longest shortest-path” between two nodes in the network), and ability to cope with change (e.g., churn). As presented in [13] scalable distributed data structures enabling structure overlay networking in single domain environments include not only DHTs but also other structures, such as Linear Hashing based structures, and tree based structures. Nevertheless, their application prevalent in cluster type applications while DHTs have a wider range of applications. As a result, DHTs were included in the design of several ICN systems. While the present specification focuses on DHTs, other hash-based distributed systems also can benefit from the innovations disclosed herein.

DHTs are decentralized distributed systems providing a lookup service for (key, value) pairs. Every node participating in the DHT can retrieve a value associated with a key (key, value) storage. Mapping is distributed among the participating nodes. DHTs typically are resistant, i.e. react well, to churn (nodes leaving/joining the system). As noted in [10], a DHT can be classified as a structured peer-to-peer system (i.e., it enables efficient discovery of data by organizing peers in relation to the key space), while other peer-to-peer systems, including such systems as the Bittorrent file sharing service, typically are unstructured (i.e., there is no a priori relation between data and peers storing this data). Since DHTs rely on associating data with storage peers, one fundamental building block of DHTs is consistent hashing [12], which is a technique that enables the addition or removal of an element without significantly changing the mapping of keys to elements. The technique requires only K/n keys to be remapped on average in response to a node joining/leaving the system, where K is the number of keys and n is the number of nodes. Therefore, churn does not lead to massive transfer of data between peers.

Design of Distributed Hash Tables is an active field of research and development. One survey [10] describes six major DHT designs (CAN, Chord, Tapestry, Pastry, Kademlia, and Viceroy). The Wikipedia DHT page [11] provides a high level description of DHTs in general and lists applications employing DHTs. We note that DHTs have reached a level of maturity such that they can be used in live, large scale products (e.g., Amazon's Dynamo [6], Bittorrent's Search Functionality [9]). As an example of implementation including advanced features, OpenDHT [6] was a free, open DHT service linked to a research project. It is discontinued, but its code base [8] (built using concept from the Pastry DHT) is still available. Notably, this implementation makes it possible to add several values associated with the same key (then a request for the key will return all values). As an example of an advanced feature, a secret (e.g., a hash value of a secret pass phrase) is provided along with a key/value pair in a PUT operation; later a REMOVE operation specifying key, value (or hash of value) and secret will remove the (key, value) pair.

A one-hop DHT was developed as part of the SEATTLE system [14] to enable a scalable Ethernet architecture, more efficient than Ethernet bridging. SEATTLE can make use of a multi-level one-hop DHT, where a new object can be inserted in a regional and/or backbone level DHT. As mentioned earlier, some proposed ICN designs [3] [4] use such a multi-level (and possibly one-hop) DHT.

2.2 Model of DHT Routing

Single-hop DHTs rely on the fact that the whole system routing table is known by all participant nodes. On the other hand, in a multiple hop overlay network, a node routing table holds many of that node's close neighbors (close in the sense that their node IDs are close within the given network geometry), and relatively fewer of that node's distant neighbors. One typical example of geometry used in DHTs is a ring, i.e., node IDs and keys are represented on a one dimensional cyclic space (e.g., used in Chord DHT); other examples of geometries are d-dimensional tori (e.g., used in CAN) and XOR (e.g., used in Kademlia).

Some key elements of DHT routing are:
Every node member of the DHT holds a routing table, associating an index from the DHT ID space to a node locator (e.g., an IP address, a FQDN, a MAC address, etc.)
Inside the DHT network, messages may be sent by a DHT node either toward a particular other DHT node (using a locator for this node, e.g., to communicate with a neighbor) or toward whichever node is responsible for a particular index from the ID space (e.g., a key to retrieve a (key, value) pair.
In this latter case, the locator of the destination DHT node is obtained based on a computation using the index and the local DHT routing table as input. Actual algorithms used depend on a particular DHT implementation, e.g., a Chord DHT node would select the node whose ID immediately precedes the index. The destination DHT node may determine that it is the final destination node, or otherwise that the message should be further forwarded toward another DHT node. Again, the algorithm to determine which node is the next hop depends on the particular DHT implementation.

### 3 SOFTWARE DEFINED NETWORKING (SDN)

Today, the software that controls forwarding rules of switches and routers is typically implemented directly in the device by the vendor. This makes it difficult to innovate in this domain because operators cannot quickly deploy new applications and services, researchers cannot experiment with new protocols in real world network settings, and it can be difficult for vendors to adapt their product fast enough to meet evolving market requirement.

SDN is a new approach to networking [15]. In SDN, control and data planes are separated, and communication between them is enabled through a SDN control protocol. The most widespread implementation of this protocol is OpenFlow [22] [23]. The primary use case for SDN today is within data centers. Nevertheless, the range of application for SDN is much wider. With SDN, operators and Researchers can manage network resources through SDN programs running on control plane entities. Today, multiple vendors implement OpenFlow devices (e.g., Cisco, HP, Juniper) which are deployed in data centers [24].

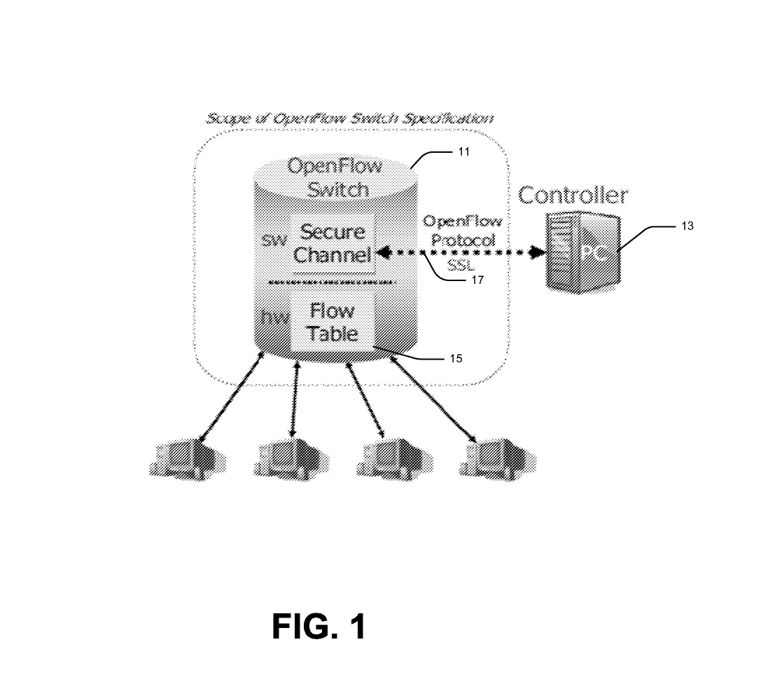

With reference to FIG. 1, the main entities in a typical OpenFlow network are OpenFlow (OF) switches 11 (responsible for packet forwarding) and the OF controller 13 (holding the network control function). The OF switches 11 contain a flow table 15, formed with flow entries. Each entry has three components: (1) a matching rule indicating which fields in the packet are to be matched with which value; (2) a list of actions, e.g., forward over a specific port or all ports, jump to a sub-table, drop, etc.; and (3) a set of counters maintaining statistics for that entry. The OF Controller uses the OF protocol to set these rules. The Controller-Switch interface is termed the “Southbound” interface. The Controller 13 runs programs providing higher level services that leverage OpenFlow (e.g., virtualized IP routing). The Controller can offer a northbound interface to higher layer functionality, enabling control of the services implemented in the Controller.

The OpenFlow specifications do not mention that matching rules can target ranges of values (as illustrated in the table below from the OpenFlow 1.1 specifications).

TABLE 1
/* Fields to match against flows */
struct ofp_match {
uint16_t type; /* One of OFPMT_* */
uint16_t length; /* Length of ofp_match */
uint32_t in_port; /* Input switch port. */
uint32_t wildcards; /* Wildcard fields. */
uint8_t dl_src[OFP_ETH_ALEN]; /* Ethernet source address. */
uint8_t dl_src_mask[OFP_ETH_ALEN]; /* Ethernet source address mask. */
uint8_t dl_dst[OFP_ETH_ALEN]; /* Ethernet destination address. */
uint8_t dl_dst_mask[OFP_ETH_ALEN]; /* Ethernet destination
address mask. */
uint16_t dl_vlan; /* Input VLAN id. */
uint8_t dl_vlan_pcp; /* Input VLAN priority. */
uint8_t pad1[1]; /* Align to 32-bits */
uint16_t dl_type; /* Ethernet frame type. */
uint8_t nw_tos; /* IP ToS (actually DSCP field, 6 bits). */
uint8_t nw_proto; /* IP protocol or lower 8 bits of ARP opcode. */
uint32_t nw_src; /* IP source address. */
uint32_t nw_src_mask; /* IP source address mask. */
uint32_t nw_dst; /* IP destination address. */
uint32_t nw_dst_mask; /* IP destination address mask. */
uint16_t tp_src; /* TCP/UDP/SCTP source port. */
uint16_t tp_dst; /* TCP/UDP/SCTP destination port. */
uint32_t mpls_label; /* MPLS label. */
uint8_t mpls_tc; /* MPLS TC. */
uint8_t pad2[3]; /* Align to 64-bits */
uint64_t metadata; /* Metadata passed between tables. */
uint64_t metadata_mask; /* Mask for metadata. */
};

3.1 Detailed SDN Summary

SDN is a key enabler of true network virtualization. SDN makes it possible for each individual hardware switch to be part of multiple Layer 2 and Layer 3 virtual networks and have each virtual network managed by an independent network controller.

Realization of the SDN paradigm requires several components to be in place:
A protocol for configuring network hardware—and hardware configurable accordingly;
Programming languages/environments to define network configuration;
Higher-level tools that permit network administrators to define network configurations that are then translated into “programs” distributed to the network hardware to define the desired virtual network.

If one were to draw an analogy to computer programming, the configuration protocol is assembly language, the “programming language/environment” is Java/Visual Basic/etc., and the higher-level tools are Web-based development environments that allow quick and easy development of web services.

The remainder of this section discusses the state of the art in developing these components.

3.1.1 OpenFlow, a SDN Enabler

OpenFlow is the protocol that provides access to computer hardware and a standardized way of configuring such hardware. Originally developed at Stanford University [22], it has become the de-facto single standard in the SDN community. This makes OpenFlow immensely important, e.g., it is as if in the early days of microprocessors (late 1970's /early 1980's) the whole world adopted a single Assembly Language and all the processors had to be programmable in that single Assembly Language.

OpenFlow is a communications protocol that gives access to the data plane of a network switch or router over the network [17]. It allows the path of network packets through the network of switches to be determined by software running on multiple routers. This separation of the control from the forwarding allows for more sophisticated traffic management than is feasible using access control lists (ACLs) and routing protocols.

OpenFlow enables networks to evolve and enables flow segregation for routers, switches, virtual switches, and access point. It provides an open protocol to program the flow-tables stored in most switches and routers. It is based on a standardized interface for adding and removing flow entries and is considered a technology-enabling network virtualization.

Switching (forwarding by destination MAC) and routing (i.e., forwarding by destination IP) are usually performed through FIB (Forwarding Information Base, also known as Forwarding Table) which are optimized for destination addresses and RIB (Routing Information Base, also known as Routing Table). RIB/FIB are populated and updated by hop-to-hop and fully distributed routing protocol (e.g., OSPF) or Border Gateway Protocol (BGP).

The idea behind OpenFlow is to introduce an external entity (the controller) to update RIB and FIB on routers and switches, allowing the definition of a fine-grained Flow Forwarding function (more than just forwarding packets based on MAC or IP addresses) [18]

3.1.2 SDN Northbound Interfaces

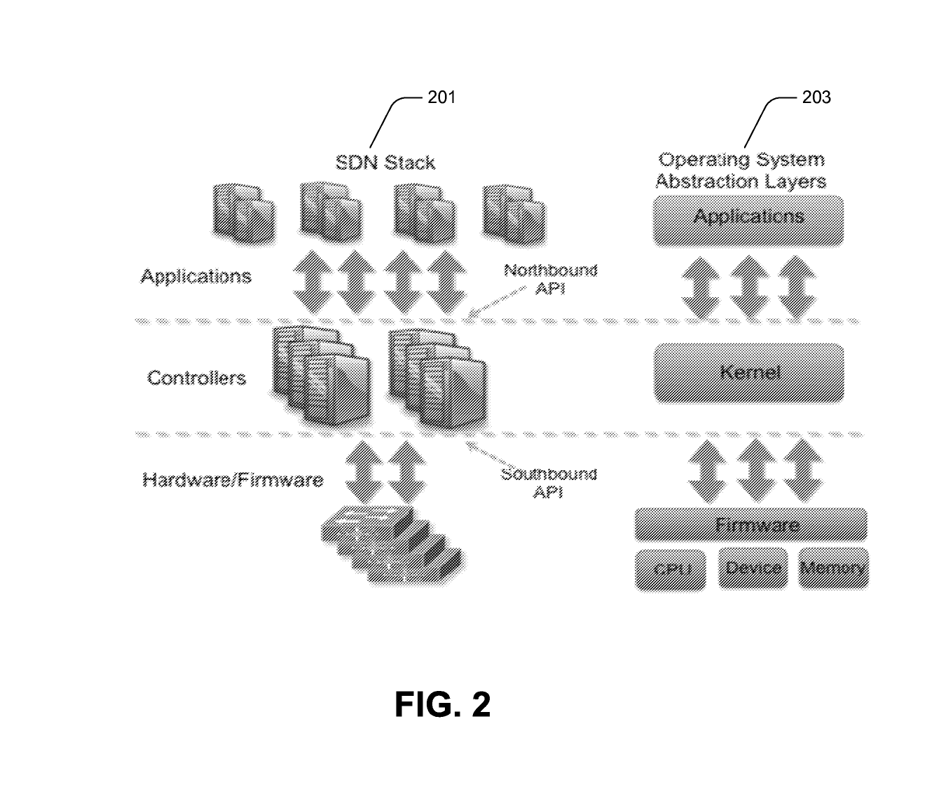

The term SDN Northbound interface relates to the Application Programming Interface (API) used by applications to interact with the SDN controllers. As presented in [15], one can analogize the SDN stack to an Operating System stack. In the text below, we review the various types of ways end users or developers can interact with the SDN controllers and analogize the SDN stack to an Operating System via FIG. 2.

Northbound API is different from, and enabled by, the SDN programmable interface. Typically, the programmable interface is designed to enable writing a range of applications, while Northbound APIs tend to be offered on top of one of those more specialized applications. At this time, Northbound APIs are defined on a per-SDN project basis. These are early attempts, there is no coordinated effort to define this type of interface at this time, and capabilities vary greatly between implementations.

FIG. 2 illustrates the parallel between an SDN stack 201 and an Operating System 203.

One primary interface offered by OpenFlow controllers in general (at least Open Source ones) is a programmatic interface, that enables developers to write applications. Some applications are typically developed along with the controller, either as an example or as full blown projects. For example, Floodlight (open source controller initiated) has a firewall application and a port down reconciliation application, Trema has a sliceable switch and a flow manager application. There is a fine line between these applications and other internal software components, e.g., Floodlight has a “learning switch” component, but this is an application in Maestro.

Those components or applications may be designed to offer a northbound interface (e.g., using REST). Floodlight offers a Northbound REST API that can be used for operations such as getting statistics, listing switches, getting the shortest path between two switches, and proactively inserting flows (reactive insertion is not supported). NOX/PDX (open source controller initiated by Nicira) provides a similar web service interface. Trema's sliceable switch application provides a REST interface.

One primary usage of the northbound interface is the integration with a cloud stack, namely OpenStack in the case of Floodlight and Ryu (another open source Controller initiated by NTT). This makes it possible for a cloud provider to interconnect safely the instances of a single tenant together.

Another usage of the northbound interface is to provide a user interface (e.g., browser based for example for Floodlight and Nox/Pox). More generally, a northbound interface can enable the development of over-the-top applications making use of OpenFlow—beyond the already given examples of a cloud stack or a user interface.

Reference [16] presents an attempt to implement content request routing using SDN.

### 4 DESIGNS COMBINING ICN AND SDN

In [25], the authors implemented the core network function of PubSub (PURSUIT's ICN architecture) using SDN (OpenFlow), which included mapping the concept of flows into ICN. In that design built upon LIPSIN, forwarding identifiers (FIs) are independent from Content ID in order to enable reusing the same FI for several deliveries between the same hosts. The SDN controller sets forwarding actions in switches, in entries keyed with the FI.

In [26], SDN (OpenFlow) is used to implement ICN following the CONET design. In that case, the key used for forwarding entries in OF switches is a tag with a one-to-one mapping to content ID. The mapping is performed by a Name Resolution System (NRS) when an interest packet (i.e., a content request) enters the CONET network through a border router. This mapping expires after use. The controller hosts the NRS and sets forwarding rules in OF switches using the tag. From the experimentation standpoint, CONET CSS is deployed under OFELIA (OpenFlow 1.0 based network) by mapping the content name into Transmission Control Protocol (TCP) source and destination ports. Flow Tables are modified in a reactive mode to get general processing rules and in proactive mode in the event of new content cached.

In papers from WinLab/Huawei [29] [30], SDN is used to enable content centric caching for HTTP traffic in an SDN domain. Enhancements proposed to OpenFlow include (a) switch capabilities announcement, (b) a new control message asking a switch to parse HTTP metadata, (c) a new message from the switch to the controller providing HTTP metadata such as content length, and (d) new behavior in the controller to process such an incoming message from the switch. Flows themselves are unmodified OF IP flows.

Work performed in Seoul National University [33] let the SDN controller perform the mapping between a content name and a private IP address where the content is stored.

In [31] a SDN controller estimates content popularity and controls forwarding rules to optimize an ICN network built using CCNx. This system uses OpenFlow to control IP flows in OF Switches, and CCNx is run as an overlay over IP. Hashes of content name are used as keys to OF flows.

4.1 Issues in Combining ICN and SDN

The ICN design presented in aforementioned reference [3], which is used herein as an exemplary base system, relies on an underlying transport protocol (e.g., such as provided by today's TCP/IP stack) to enable the DHT-based content location resolution and later to transport content requests and responses. This design requires support from the internal routing protocol (such as OSPF) to help form the DHT. Moreover, it also requires all content routers to be part of a DHT network, and therefore to implement the full DHT stack. The development of SDN (including the OpenFlow protocol) enables centralization of traffic control inside a domain.

The designs described in the present document leverage SDN/OpenFlow and enhance it as needed to support more centralized control of DHT lookup and content transport inside a domain. This work has a direct application in certain ICN designs, but can also be useful more generally for any DHT-based systems. Prior work combining ICN and SDN consisted in having the controller set up flows using a key associated with a particular content request, or possibly several related content requests (e.g., in [25] the flow can be associated with several content requests/responses between two nodes). The key itself can be a forwarding ID calculated by a topology layer in [25] a tag derived from the content ID in [26], a hash of content name in [31], or an existing key used today for IP flows. In none of the reviewed cases is SDN involved in facilitating DHT based lookup. Moreover, in many cases the SDN controller is involved on a per-content request basis, which leads to a potential bottleneck, while the present work aims to limit SDN control traffic to control plane operations only (i.e., individual content requests or publications should not require involvement of the SDN Controller).

### 5 GENERAL OVERVIEW

Therefore, this specification describes how SDN can be used to facilitate the operation of DHT-based ICN designs (and more generally DHT-based systems), especially in term of scalability and network efficiency.

It also generalizes these concepts by describing in more detail a SDN mechanism that can be used to control hash routing, which can then be used by upper layer SDN applications such as DHT or ICN protocol stacks.

This specification makes the usual distinction between control plane and data plane. Control plane functions include, for example, system configuration, management and control. These are typically performed infrequently. On the other hand, data plane functions include, for example, the forwarding of data, and are therefore typically invoked frequently, e.g. on each arriving packet, or on each arriving data object. Control plane may sometimes be referred to as the “slow path”. The data plane may sometimes be referred to as “fast path” or “forwarding plane” in the literature.

One aspect of the present invention is moving the routing aspect of DHTs down to the network fabric, and more generally to splitting the DHT stack functionalities into control plane and data plane. Control plane features include joining, leaving, and maintaining DHT node status in the DHT network, which ultimately result in building and maintaining the routing table. Control plan features also include migrating (key, value) pairs from one node to another in order to support join/leave operations. Data plane features include setting a new (key, value) pair and associating a value with a particular key. Control plane functions can be efficiently implemented in a centralized entity, for example by an enhanced SDN controller. The DHT routing table, which is currently built and maintained by every DHT node, can be effectively built by the enhanced SDN controller and programmed into the network (e.g., the network switches) making use of a new key-range forwarding SDN capability. This effectively programs the DHT routing table inside the network, instead of inside every DHT node.

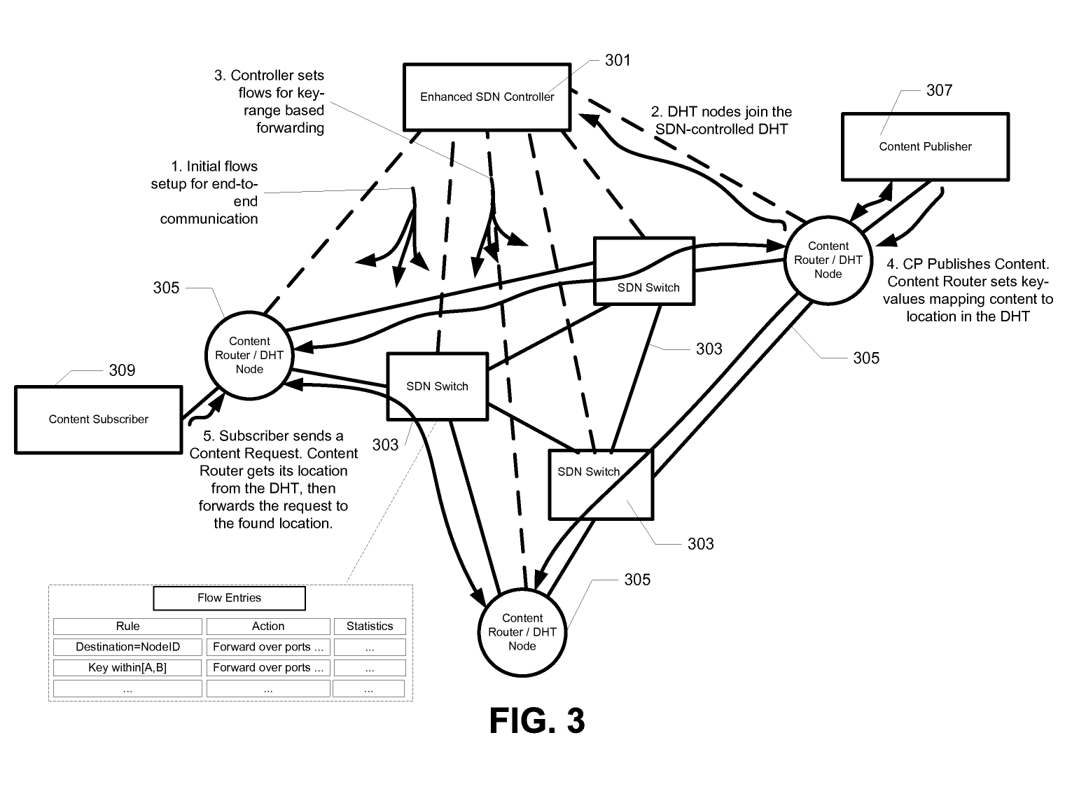

The first described embodiment of this design is discussed in detail below in section 6.1 and illustrated in FIG. 3 and enables efficient ICN operations for ICN designs which rely on a mapping service built over DHT. In section 6.2, an alternate and more general embodiment enables efficient use of DHTs within a domain. Section 6.3 further generalizes this work to enable a DHT spanning multiple domains. Combinations of the mechanisms described in sections 6.1, 6.2, 6.3 are possible, and, for example, can enable efficient ICN operations that make use of a multi-domain DHT NRS.

At first glance, it may seem counter-productive to centralize the control plane of a DHT because: (1) this can introduce a single point of failure, which DHTs are designed to avoid and (2) entirely centralizing the DHT into a single database is more intuitive. However, as to the first point, this invention is primarily aimed at SDN-controlled networks, and SDN domains already separate network control from data plane, and already have to deal with failure of the controller, for example, using redundancy schemes. Therefore, this design builds upon this infrastructure and benefits from the failsafe measures that are inherent to deploy SDN. Moreover, this design does not involve the SDN controller for every content request or DHT operation, but only for significant changes in the DHT (e.g., when new nodes join or leave the DHT), which reduces the impact of a temporary failure of the SDN controller, especially in cases where the DHT is made of stable nodes, and where multiple hash functions can be used concurrently to implement redundancy within the DHT. As to the second point (the alternative of replacing the DHT with a fully centralized solution), using a DHT for data plane avoids the cost of deploying and maintaining a single database, and dimensioning/designing the network for centralized access to that database. Finally, another question is what is the gain offered by using SDN to control a DHT, as opposed to single hop DHT, in which every node includes the whole DHT routing table. The advantages of the SDN-based solution: (1) a centralized control can be easier to manage, upgrade, and debug, (2) it can ensure that the state of all DHT nodes is consistent at all time and can react quickly to a node failure, (3) it simplifies the implementation in the DHT node, (4) it enables nodes which are not part of the DHT to interact with the DHT without passing through a DHT node as a gateway (therefore, no need to configure the gateway or to discover it).

Section 7 below describes the enhanced SDN system in more detail. In particular, it discusses the low-level key-range routing control SDN discussed in section 6 more generally as a more flexible Hash-Routing control (HRC) SDN feature. In particular, the exemplary OpenFlow signaling is discussed more generally, i.e., not only matching a specific field and use range routing on this field, but also calculating a hash-value on a specific field, and applying range-based routing on this value, which effectively is a general form of hash-routing. SDN control of Hash-Routing includes a northbound interface, SDN control logic, a Southbound (e.g., OpenFlow) interface update, and logic within the SDN router/switch forwarding engine.

Section 7 further describes SDN applications making use of this hash-routing control feature, especially describing their own northbound API, and how they translate northbound API operations into hash-routing south-bound API calls.

Described herein are designs to implement an ICN Name Resolution System (NRS), or other structured peer-to-peer network, inside a domain. General aspects of this design include:
DHTCP (Distributed Hash Table Control Plane) and/or enhanced SDN controller receives the range of keys for which a node (with Node ID) is responsible;
DHTCP and/or enhanced SDN controller sets forwarding rules where name resolution requests (e.g., ‘DHT GET value for a given key’) and publications to the name resolution system (e.g., ‘DHT SET (key, value) pair’) messages for a content ID (or derived key) within the proper range (and typically not mentioning a destination node ID) gets forwarded toward the node with said Node ID;
OF protocol can be enhanced to enable a forwarding rule mechanism based on a value range in OF switches and routers. Additional information elements include range specification, DHT network ID and protocol;
   This includes enhancing the OpenFlow protocol to support hash routing control in a general case, i.e., not only for a range of values of a certain field, but also for a range of values of the hash value calculated from a certain field;
   This also includes an enhancement to the internal representation of a flow in a SDN device, and of the forwarding logic.
For initial DHT setup:
   Alternative 1: Direct DHT Node-SDN Controller Interface:
      SDN Controller provides a northbound interface that enables nodes to join/leave a DHT as well as other DHT control plane communication between a specialized SDN application and a DHT node;
      SDN Controller sets forwarding rules in the network to enable key-range based forwarding toward DHT nodes holding (key, value) pairs in this range;
   Alternative 2: External DHT Control Plane function uses a SDN Northbound Interface:
      A DHT Control Plane function provides an API that enables nodes to join/leave a DHT as well as other DHT control communication;
      SDN Controller provides northbound interface to set the key ranges associated with a particular node;
      SDN Controller sets forwarding rules in the network to enable key-range based forwarding toward this node. DHTCP uses this northbound interface.
SDN-enabled ICN NRS can be used as part of an ICN system based on a hierarchical name resolution system, where:
   A Content Router receives a content request;
   Content Router sends a name resolution request using the content ID toward a neighbor switch;
   Neighbor switch makes forwarding decision based on content ID;
   Content Router receives name resolution response indicating content location;
   Content Router forwards content request toward content location;
Independently from ICN, this specification discloses multiple SDN-enhanced DHTs:
   Within a single domain;
   Across several cooperating SDN domains;
   Across several SDN and non-SDN domains.

### 6 DETAILS OF DESIGN

6.1 Enabling DHT-Based ICN Systems using SDN

A first embodiment pertains to ICN system such as [3] or [4], relying on one or more (possibly hierarchical) single-domain DHTs to map a content ID to a locator. Support for multiple domain DHT-based resolution is not considered in this section in order to focus on the core mechanisms, but is discussed in the third embodiment in section 6.3. This first embodiment can therefore be extended to an ICN system making use of such multi-domain DHT.

FIG. 3 is an overview of an exemplary setup and request/response of a SDN controlled ICN network in accordance with an embodiment. Not all messages are represented, the goal being to illustrate the different phases that will be further developed later in this specification. Also, logical connectivity between publisher/subscriber and content router is represented as a direct link for clarity, but the actual physical path could be over one or more intermediate elements.

In this embodiment, as illustrated in FIG. 3, in steps 1-3, the enhanced SDN Controller 301 of a domain participates in building the distributed Name Resolution System of this domain, including setting up initial flows for end-to end communication (step 1) and registering DHT nodes that join the DHT (step 2). In addition, it sets key-range-based forwarding rules in the SDN/OF switches 303 (step 3), using enhanced SDN/OF protocol in such a way that get/set messages for “name-location” (key, value) pairs are forwarded toward the DHT node 305 that holds that (key, value) pair, by using forwarding rules which depend on the key being within a range of values (note that the key typically is the content ID or derived from the content ID). This effectively implements a network-assisted one-hop DHT. At a later time, in step 4, the content publisher 307 makes use of this key-range-based forwarding mechanism to efficiently store content publication data (e.g., content ID and locator of the storage node for this content object or to the next hop toward this storage node) in the DHT. Yet later, in step 5, as a consequence of a content request initiated by an application (at a content subscriber node 309), a name resolution request (i.e., a DHT ‘get’ message) is sent to the network, and reaches the proper DHT node 305 holding the location information using key-range based forwarding, resulting in a response message holding a locator of the content source, or at least the next hop toward this content source. Following this step, the content request can then be forwarded toward the next hop using another forwarding scheme, e.g., forwarding based on strict-match of destination IP address.

This method can be used to implement an NRS-based ICN system (such as the one described in [3] efficiently in a SDN domain (i.e., content routers also are DHT nodes and form the NRS). The control interfaces between the controller and the overlay nodes may be indirect, e.g., may pass through an overlay control function which uses a northbound interface of the SDN controller. Also, the requester nodes do not need to know the DHT routing table, and, thus, even nodes which are not part of the DHT can request a (key, value) pair from this DHT (e.g., in [4], a completely different set of nodes may be Content Routers and NRS DHT nodes). As a related advantage, the Name Resolution System can be implemented independently from the rest of the ICN system, even using another technology than DHT, effectively hiding the storage behind a DHT ‘get/set’ network API, e.g., for small domains, all name-location (key, value) pairs may be stored in a single node.

6.1.1 Single-Domain DHT-Based NRS

In a single-hop DHT, every node needs to maintain the whole routing table, i.e., at least one entry per node present in the DHT network. In a multi-hop DHT, nodes maintain a subset of this routing table. An algorithm specific to the DHT implementation is run by a sender node wishing to send a message related to a given key (e.g., a get or a publish message). This algorithm correlates the key with a particular node which is responsible for storing the related (key, value) pair. As mentioned above, this algorithm depends on the particular DHT design. In this invention, the whole DHT routing table as well as the key-node association algorithm is implemented as a distinct network function, herein termed “DHT control plane function” (DHTCP). DHTCP can be implemented as a separate entity (single node or distributed function) or as a part of the SDN Controller stack.

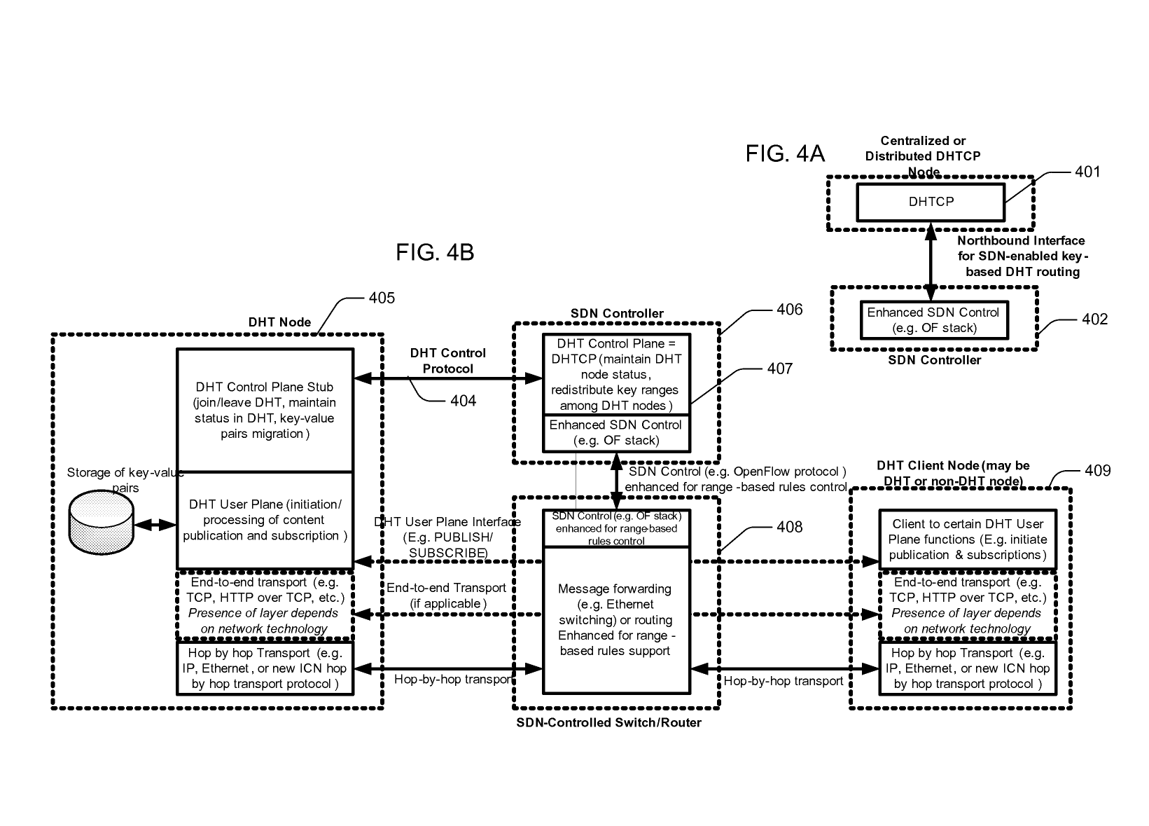

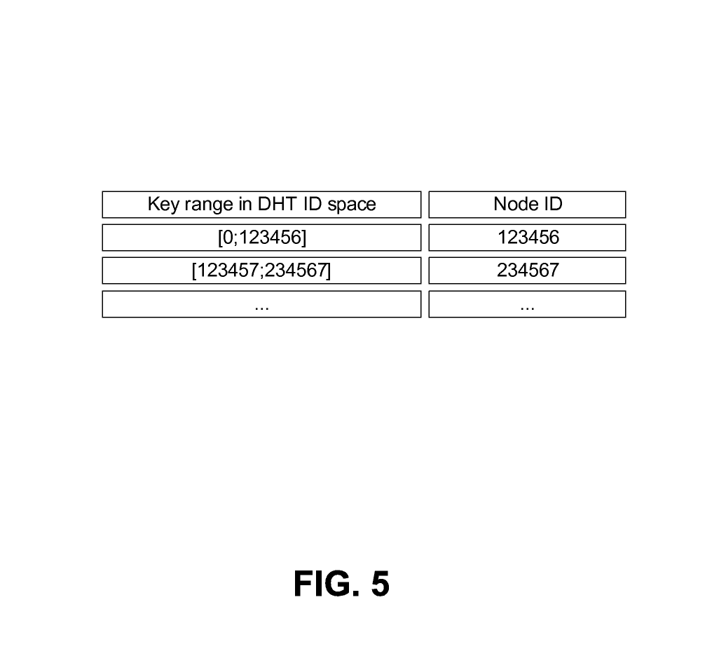

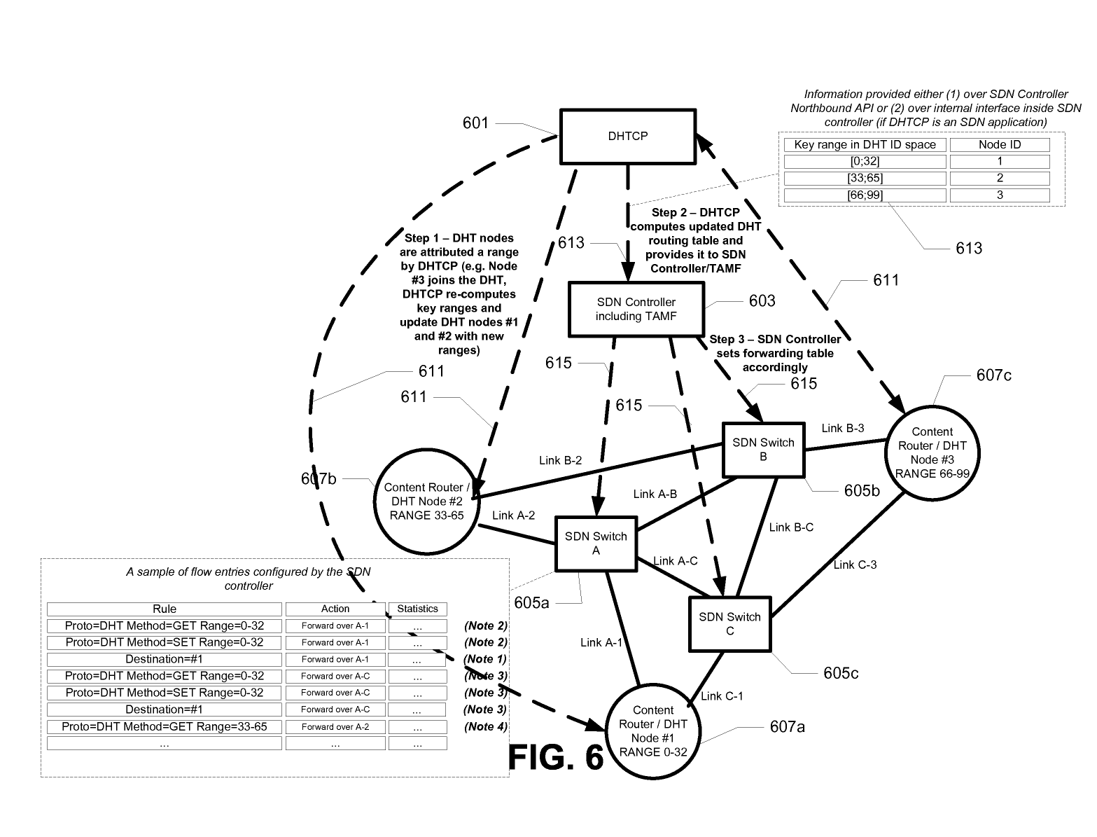

FIG. 4A illustrates an exemplary implementation of DHTCP as a separate entity. In this implementation, DHTCP 401 is an SDN northbound API client (i.e., the interface between the SDN Controller 402 and DHTCP 401 is a SDN northbound API).

FIG. 4B, on the other hand, illustrates an exemplary implementation of DHTCP as a part of the SDN Controller stack. In this implementation, DHTCP 407 is an SDN application and the interface 404 between the DHT node 405 and the DHTCP 407 in the SDN controller 406 is a SDN Northbound interface. For sake of completeness, FIG. 4B also illustrates a SDN-controlled switch/router 408 and a DHT client node 409 and shows the various interfaces between the SDN controlled switch/router 408 and the DHT node 405, SDN Controller 407, and DHT client 409. Below DHTCP stands a topology-aware key-range-based routing mapping function, which translates DHT routing information into configuration for SDN/OF switches and routers 408 in the SDN domain. The overall system implements a network-assisted one-hop DHT network.

DHTCP offers an interface to DHT nodes to join or leave the DHT network and also for maintenance messages (e.g., keep-alive messages; e.g., update message to enable transfer of (key, value) pairs between nodes after a node joins or leaves). Therefore, individual DHT nodes do not need to implement this part of the DHT stack, which is effectively transferred to the DHTCP function. The DHT nodes still need to implement data plane functions (e.g., to send and receive get and set messages), but only need to communicate with the DHTCP API 407 for control plane functions (join/leave/keep alive/etc.). As a result, DHTCP 407 is aware of the full DHT routing table (i.e., node locators, and node IDs in DHT ID space), as well as the key-node association algorithm. DHTCP is therefore able to partition the DHT identifier space into Nr ranges, with Nr≧Nn, where Nn is the number of nodes in the DHT. For example, in the simplest case, Nr=Nn. In other cases, such as the SEATTLE one-hop DHT [14], there may be several virtual nodes per physical node, resulting in Nr>Nn, but Nr should stay bounded, typically in a linear fashion with Nn. In this particular example, we would have Nr≦Nv*Nn, where Nv is the maximum number of virtual nodes per physical node.

Finally, DHTCP can build the key-range-based routing table for this DHT. FIG. 1 shows an exemplary DHT key-range Routing Table (in this example, the ID space is uni-dimensional, such as in the Chord DHT design). This key-range routing table typically is part of the state of the DHTCP function (i.e., DHTCP maintains this state based on nodes joining/leaving the DHT).

Messages exchanged between DHTCP 407 and DHT nodes 405 typically should make it possible for the DHTCP to inform each DHT node of the key range it is responsible for (e.g., in JOIN response, in keep-alive response, and/or using indication messages from DHTCP to the DHT nodes). This information is necessary for the data plane DHT function on each node to properly process incoming get/set queries, and to enable migration of (key, value) pairs to a new node, for example. In an example of migration strategy, upon receiving a JOIN request, the DHTCP computes the new ID ranges associated with all DHT nodes, and requests a migration from certain DHT nodes (typically a small number of nodes, thanks to the consistent hashing technique) toward the given new node ID. Then it updates the network with updated ranges and deletes the migrated data from the old DHT nodes.

In addition to migration, data replication also is important in DHTs in order to enable recovery from individual DHT node failures. This feature typically can be considered as a control plane function, where the DHTCP computes the replication map (i.e., which key range should be replicated in which DHT node) and provides it to DHT nodes, which execute the replication using destination-based forwarding (i.e., messages are forwarded by routers/switches based on the destination node ID, not the content-ID/key). Other replication strategies exist, such as using different hashing functions to compute the key. That is, two (or more) different hashing functions can be provided, each generating different value for a given key, each value identifying a different location of the data. Such an embodiment can be implemented using this invention without any further change in the network side since then only the end points are involved. Publishers may calculate Nh hashes and send Nh SET/PUBLISH requests, and subscribers may select one of the hash functions and send one related GET/SUBSCRIBE request.

Referring to FIG. 6, the key-range-based routing table is an input to a Topology-Aware key-range-based forwarding Mapping Function (TAMF) in the controller 603, which can determine how to configure the SDN/OF switches and routers 605 to forward traffic pertaining to a certain key range (typically only for messages matching a given protocol and method) toward the proper DHT node. For a given SDN/OF Switch/Router, flow entries forwarding adjacent key ranges over the same interface may be merged by the TAMF (or by the switch/router) into a single entry. One advantage of this design is that the DHTCP can allocate Node IDs in such way as to maximize such merging opportunities. In any case, the number of individual OF switch/router forwarding entries for this DHT will stay below Nr, defined above. Then, TAMF can use the enhanced SDN protocol (e.g., OpenFlow) to configure range-based forwarding rules in network switches/routers. Alternately, TAMF may also translate range-based rules into strict-match rules before configuring the network.

For sake of illustration, this transformation can be performed using the following exemplary “range-to-strict matching translation” algorithm. Initially, all values in the range are listed in binary form, and then formed into groups with the longest series of common bits. To illustrate, consider the range 20-30 (in base 10) as shown below (including the values adjacent to that range). This range starts with 10100 (base 2) and ends with 11110 (base 2).
19=10011 base 2
20=10100 base 2
21=10101 base 2
22=10110 base 2
23=10111 base 2
24=11000 base 2
25=11001 base 2
26=11010 base 2
27=11011 base 2
28=11100 base 2
29=11101 base 2
30=11110 base2
31=11111 base 2

The range 20-30 can be expressed by a criterion. In this case, the criterion is the union of the following four bitmasks (where x is a wildcard bit matching any of 0 or 1): 101xx base 2, 110xx base 2, 1110x base 2 and 11110 base 2. The algorithm can for example be expressed as:
1. Start with first value in range, and set group index n=0.
2. group(n) is defined using the shortest prefix which matches the current value and does not match the previous value. Set group(n)'s ‘origin prefix’ to this prefix, and group(n)'s ‘origin value’ to the current value, e.g., in the present example, it would start at 20 with prefix 101xx.
3. Keep incrementing the value, as long as the prefix for group(n) keeps matching this value, and as long as the value stays in the range. Steps 4, 5, 6 are possible stop conditions for this loop.
4. If the latest value does not match the group but is still in range, then it's time to create a new group (n=n+1) and go to step 2.
5. If the latest value does no match the group and is not in range, end (go to step 7) 6. If the latest value matches group(n)'s prefix and is not in range then the prefix of group(n) is too long. We backtrack to the origin of group(n) (i.e. set group(n)'s value to its origin value, and set group(n)'s prefix to its origin prefix). We then increase group(n)'s prefix's length by one bit. Then, set group(n)'s ‘origin prefix’ to this new prefix. Then go to step 3.
7. At this point, the algorithm is completed. Groups exist for 0 . . . n, each group is defined by its prefix.

Assuming that an existing OpenFlow field is used to store the hash value in the packet, and that this field supports bitmask (e.g., Ethernet field or IP address field), then the existing OpenFlow protocol can be used without modification.

This operation typically increases the number of rules in a manner highly dependent on the range. This translation is an exemplary way to enable this design without modifying the OpenFlow protocol. However, in some cases, it may be more efficient to modify the SDN/OF protocol to implement ranges, and enhance the SDN device to understand and implement this range matching. If ranges are enabled in an enhanced version of the SDN/OF protocol in accordance with the present invention, then, in one embodiment, the OF switch/router may internally implement the aforementioned range-matching by decomposing range matching into a plurality of bit-field strict matchings (rather than performing the algorithm in the SDN controller). Beyond this simple implementation, high speed range matching algorithms have been studied already, e.g., in [34]. Note that key-range matches typically will be combined with strict matches on other fields. Typically, ‘GET’ (or ‘SUBSCRIBE’) and ‘SET’ (or ‘PUBLISH’) request methods of the proper DHT data plane protocol should be identified by OF switches/routers using strict match of certain message fields. For those messages only, the key information element should be evaluated for inclusion in a key-range, and, if there is a match, the appropriate next-hop is determined from the forwarding entry.

The above mentioned techniques, including the technique of translating range-based rules into strict match rules has broader applications than the above-described embodiment. For instance, it may be used to support any of the ICN and hash routing techniques described hereinbelow.

Referring again to FIG. 6, it illustrates signal flow in connection with DHT maintenance in accordance with an embodiment. It demonstrates signal flow for a DHT node joining the DHT and receiving a node ID, updating of key range allocation upon such an event (i.e., a node joining or leaving the DHT), and updating of SDN switch flow tables. In this exemplary implementation, the DHTCP 601 and an SDN Controller 603 that includes TAMF are associated with three DHT nodes 607a, 607b, 607c. Also, there are three SDN switches 605a, 605b, 605c. In this example, DHT node 607c is joining the DHT. Thus, DHTCP 601 needs to reassign (key, value) ranges among the, now, three DHT nodes in its domain. Thus, DHTCP 601 recalculates key ranges and sends a range assignment to new node 607c and updates the key ranges for previously existing DHT nodes 607a and 607b, as shown by messages 611 (step 1) in FIG. 6. Next, the DHTCP 601 computes an updated DHT routing table and provides it to the SDN Controller/TAMF 603, as shown by message 613 (step 3). Finally, the SDN Controller 603 calculates forwarding tables for the SDN switches 605a, 605b, 605c in its domain and sends those forwarding tables in messages 615 to those switches.

Table 620 in FIG. 6 shows an exemplary forwarding table for SDN switch 605a. Specifically, for example, the third entry in forwarding table 620 describes a destination-based entry (e.g., used for regular IP traffic, including DHT GET/SET response messages for example). The first and second entries in forwarding table 620 describe key-range based entries used for DHT GET/SET messages. The fourth, fifth, and sixth entries in forwarding table 620 describe fallback entries that may be used if Link A-1 is down. Finally, the seventh and last entry in forwarding table 620 is the first of the entries related to requests relating to (key, value) pairs in ranges maintained by the other DHT nodes in the domain. There would be additional similar entries in the forwarding table of SDN switch 605a, but they are omitted for sake of brevity.

One example of implementation for messages 615 (step 3) in FIG. 6 enhances the OpenFlow protocol, especially the structure representing fields to match against flows. In this example, the key range is applicable to an object ID information element that is supposed to be well known by the OF switch/router. An alternative, more complex description could enable applying the range matching to various fields (e.g., adding an enumeration index pointing to one of several known fields, or specifying the start and end of a bit field). Table 2 below shows an enhanced version (the underlining denoting the enhancements) of the OpenFlow ofp_match data structure (see Table 1) in accordance with one embodiment having two new entries, namely, oid_range_value_min[4] and oid_range_value_max[4].

TABLE 2
/* Fields to match against flows */
struct ofp_match {
uint16_t type; /* One of OFPMT_* */
uint16_t length; /* Length of ofp_match */
uint32_t in_port; /* Input switch port. */
uint32_t wildcards; /* Wildcard fields. */
uint8_t dl_src[OFP_ETH_ALEN]; /* Ethernet source address. */
uint8_t dl_src_mask[OFP_ETH_ALEN]; /* Ethernet source address mask. */
uint8_t dl_dst[OFP_ETH_ALEN]; /* Ethernet destination address. */
uint8_t dl_dst_mask[OFP_ETH_ALEN]; /* Ethernet destination address
mask. */
uint16_t dl_vlan; /* Input VLAN id. */
uint8_t dl_vlan_pcp; /* Input VLAN priority. */
uint8_t pad1[1]; /* Align to 32-bits */
uint16_t dl_type; /* Ethernet frame type. */
uint8_t nw_tos; /* IP ToS (actually DSCP field, 6 bits). */
uint8_t nw_proto; /* IP protocol or lower 8 bits of ARP opcode. */
uint32_t nw_src; /* IP source address. */
uint32_t nw_src_mask; /* IP source address mask. */
uint32_t nw_dst; /* IP destination address. */
uint32_t nw_dst_mask; /* IP destination address mask. */
uint16_t tp_src; /* TCP/UDP/SCTP source port. */
uint16_t tp_dst; /* TCP/UDP/SCTP destination port. */
uint32_t mpls_label; /* MPLS label. */
uint8_t mpls_tc; /* MPLS TC. */
uint8_t pad2[3]; /* Align to 64-bits */
uint32_t application_protocol; /* an application protocol number (e.g., DHT
for ICN protocol A version 1) */
uint32_t application_specific_index; /* For example, in the case of a
DHT protocol this could be the DHT network ID
*/uint32_t application_specific_method; /* For
example, in the case of a DHT protocol this could be GET or SET */
/* Additional alignment fields may be included */
unint64_t oid_range_value_min[4]; /* First value of Object ID within
the range (256 bits value) */
unint64_t oid_range_value_max[4]; /* Last value of Object ID within
the range (256 bits value) */
uint64_t metadata; /* Metadata passed between tables. */
uint64_t metadata_mask; /* Mask for metadata. */
};

In the example where the DHT protocol is above UDP or TCP, the data structure above would set the UDP or TCP port to the required value. The IP address could be set, for example, to a specific anycast address, which all DHT message would need to use. The interest of such an anycast IP address is that any non-SDN router can be configured to route such packets toward the part of the network where the SDN-enabled router or switches will be able to forward the request toward their destination.

The entries “application protocol/index/method” and “oid range min/max” typically should refer to an additional description of the application protocol. This additional description can for example use regular expressions to describe how to match packets and extract the relevant piece of information from them (note that regular expressions are used today to enable packet matching in deep packet inspection systems). In another example, the application protocol can be binary and it can be sufficient to specify offsets for matching and capture of information from the packet. In any case, this additional application protocol description may be part of the configuration of the switch/router, either through pre-configuration or through configuration by the SDN controller.

The field “application_specific_index” can enable matching a DHT network ID, which is used to discriminate between several DHT networks.

One assumption here is that the network elements controlled through SDN are sufficient to enable proper range-based forwarding toward a destination. For example, all switches/routers of the domain may be SDN-controlled. Alternately, only core switches/routers of the domain may be SDN controlled, and the other routers/switches may be configured in such a way that DHT GET/SET messages will be properly forwarded toward these core router/switches. For example, DHT GET/SET messages that are meant to be forwarded based on key range could systematically use an anycast destination IP address. Non-SDN controlled switches/routers can forward these messages toward an OF-controlled router/switch, which will properly forward the message as described in this work.

In a more recent version of the OpenFlow specification (v1.4.0, https://www.opennetworking.org/images/stories/downloads/sdn-resources/onf-specifications/openflow/openflow-spec-v1.4.0.pdf), the format of match fields was modified and is now realized using a compact type-length-value (TLV) encoding, the OpenFlow Extensible Match (OXM). OXM TLV's type is composed of an “OXM class” and a “match field” (as part of the type), which states on which packet field this TLV applies; an example of class is the “OpenFlow Basic” class, and example of values within this class include UDP Source Address, Multi-Protocol Label Switching (MPLS) Label, etc. The header additionally includes a bit indicating if a bitmask is present and the length of the field. The value of the TLV can be the desired value of the field, plus if appropriate a bit mask which indicates which bits of the value should be matched.

One way to implement ranges in this scheme is to add a new flag in the header indicating that the value encoded is a range, i.e., a pair of value_min and value_max. This new flag may require extending the length of the header, e.g., by one byte. Alternatively, since the basic length of the value is known from the type, simply setting the existing mask flag to 0 while keeping the length doubled from the normal value can implicitly mean that the value of the TLV is a range. In all cases, the encoding of the range in the TLV can simply be the concatenation of 2 values (min and max).

6.1.2 ICN Publish and Subscribe Operations

In the context of an ICN design using a multi-level hierarchical DHT as part of content routing [3], every single DHT level is implemented inside a single domain. All or some of these domains may implement the SDN-enabled DHT routing described above. Let's consider that the system is in steady state, i.e., each DHT network is configured and maintained by its DHTCP function, and each DHT node holds the (key, value) pairs it is responsible for.

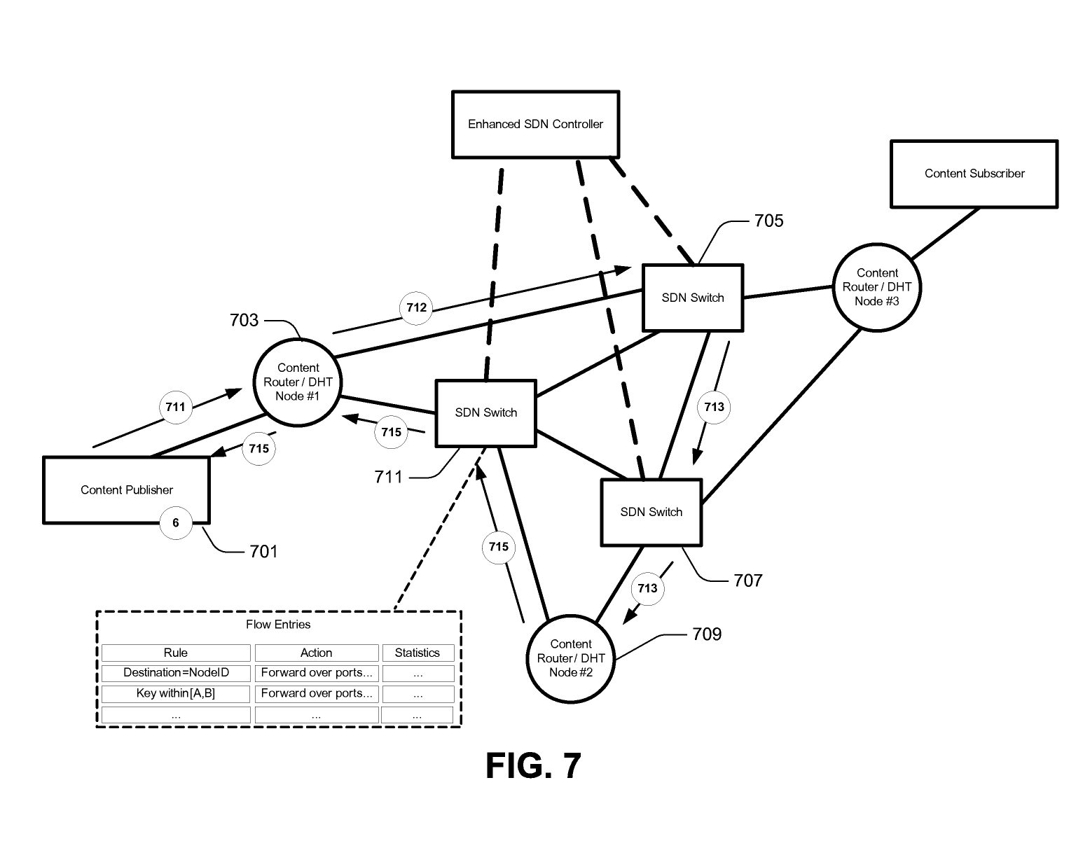

The steps involved in an exemplary content publication are shown in FIG. 7. Note that logical connectivity between publisher/subscriber and content router is represented as a direct link for clarity, but actual physical path could be over one or more intermediate elements. In the first step, the subscriber node 701 sends a PUBLISH (aka SET) request 711 for a content object it stores (or knows the location of) to a content router 703. The subscriber node 701, for example, may be an end user device or a border content router of another domain. The PUBLISH request 711 includes a (key, value) pair, where the key is the content ID or data that is derived from a content ID and where the value is the location where the content object is stored.

The content router 703 sends a PUBLISH request 712 over one or more interfaces facing the inside of its domain. There is no need for a destination information element, but the message includes information elements holding (a) a key (content ID or data derived from a content ID), and (b) a DHT data plane protocol header (e.g., IP/UDP/HTTP POST/XML).

Note that, in FIG. 7, the Content Router 703 makes a sub-optimal choice for the outgoing interface, but the message is still correctly forwarded. Alternately, the content router 703 also could be SDN-controlled, including with range-based flow entries, and in this case would be able to make the optimal choice for any key.

When reaching an intermediate node (OF switch or router) 705, the intermediate node matches the content of the message header with its forwarding table. Based on strict match of some information elements such as protocol and method, the intermediate node 705 proceeds with matching the key with key-ranges associated with different forwarding entries, and, if the key belongs to one of these ranges, it selects the related forwarding entry and message 713 is forwarded (possibly through one or more switches/routers, e.g., switch 707) to the relevant content router that is responsible for that key, e.g., router 709. The DHT node 709 stores the (key, value) pair and replies to the source node with message 715.

The reply message 715 is forwarded using destination-based forwarding rules. For example, the locator (e.g., IP address) of the content subscriber 701 could be obtained from the original request and used as the destination of the response. Other schemes are available, such as source routing such as using the locator of content router 703 which will relay the response to the content subscriber 701.

In the diagram, the return path is different from the request path (passing through SDN switch 711 to content router 703 to content publish 701, rather than through SDN switch 707 to SDN switch 705 to content router 701), but if a source routing scheme is used (i.e., forwarding path is recorded in the original request message) the request and response path would be identical.

The role of the reply message (5) typically is to indicate the success or failure of the publication operation.

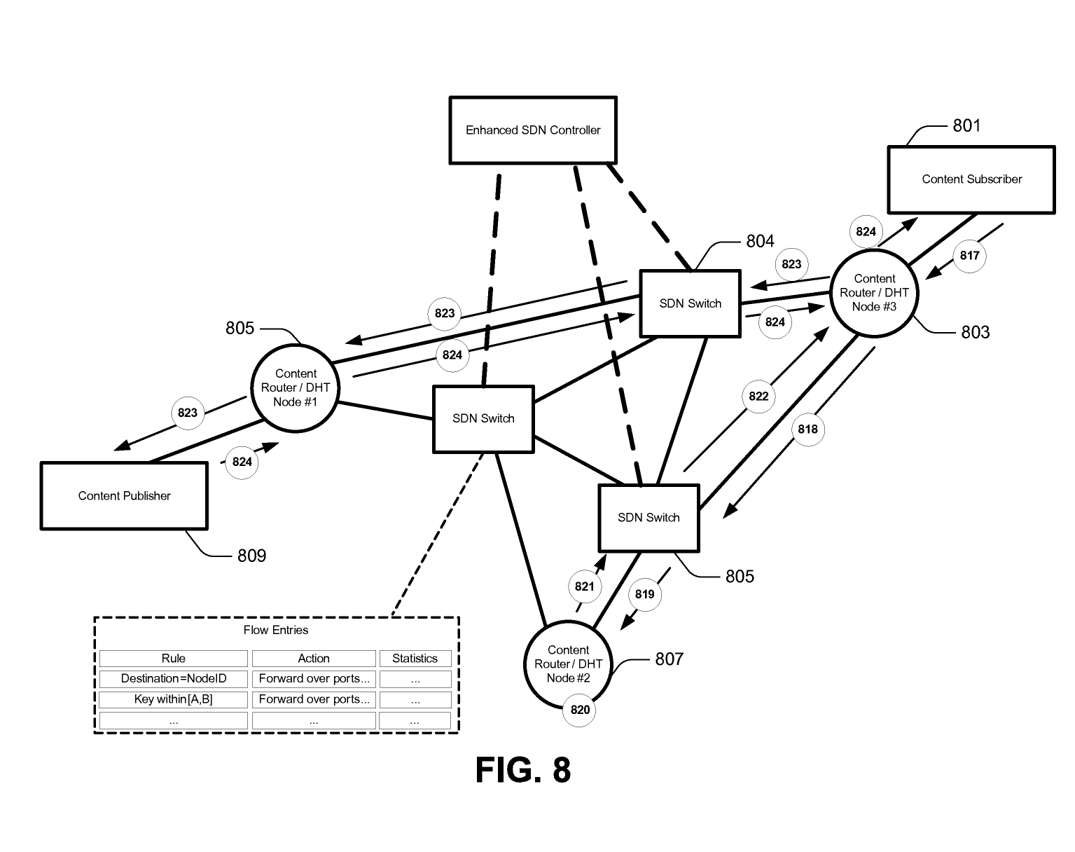

The steps involved in content requests are shown in FIG. 8. Note that logical connectivity between publisher/subscriber and content router is represented as a direct link for clarity in FIG. 8, but the actual physical path could be over one or more intermediate elements. A requester node 801 sends a SUBSCRIBE request 817 to a content router 803.

Content router 803 sends a NAME RESOLUTION (a DHT GET message) request message 818 over one or more interface facing nodes (e.g., SDN switch 805) from its own domain. Again, there is no need for a destination information element, but the message 818 includes information elements holding (a) a key (content ID or derived from content ID), and (b) a DHT data plane protocol header (e.g., IP/UDP/HTTP GET/XML).

The DHT GET message 818 is forwarded as shown by message 819 to the content router 807 containing the corresponding (key, value) pair.

The DHT node 807 responsible for this key reads the (key, value) pair from its local storage, as represented by 820, and includes it in its reply message 821. The value is a locator where the content with the given content ID/key can be retrieved.

The message 821 is forwarded through the network fabric from SDN switch 805 to content router 803 via message(s) 822 until it reaches the content router 803. Note that the response messages 821 and 822, do not necessarily use range based routing. For example, the responding DHT node may simply send the response back to the requesting content router using regular IP routing (e.g., using the IP address of the requesting content router as destination IP address of the response).

Using the locator from the response 821, 822 as the destination, the content router 803 forwards a SUBSCRIBE request 823 toward the content source 809 through the network fabric (in this case SDN switch 804 and content router 805). Note that the locator may point to the content source, a cache, or a border router that will forward the request further outside of the domain.

The Content Source 809 sends back the content object in message 824, to the subscriber 805 through the network fabric, e.g., through content router 805, SDN switch 804, content router 803, and, finally, to the requesting content subscriber 801. For example, this can be done using regular IP routing, where the content source 809 sends the response using the IP address of the subscriber 801 as destination IP address.

6.1.3 Separation between Content Routers and NRS

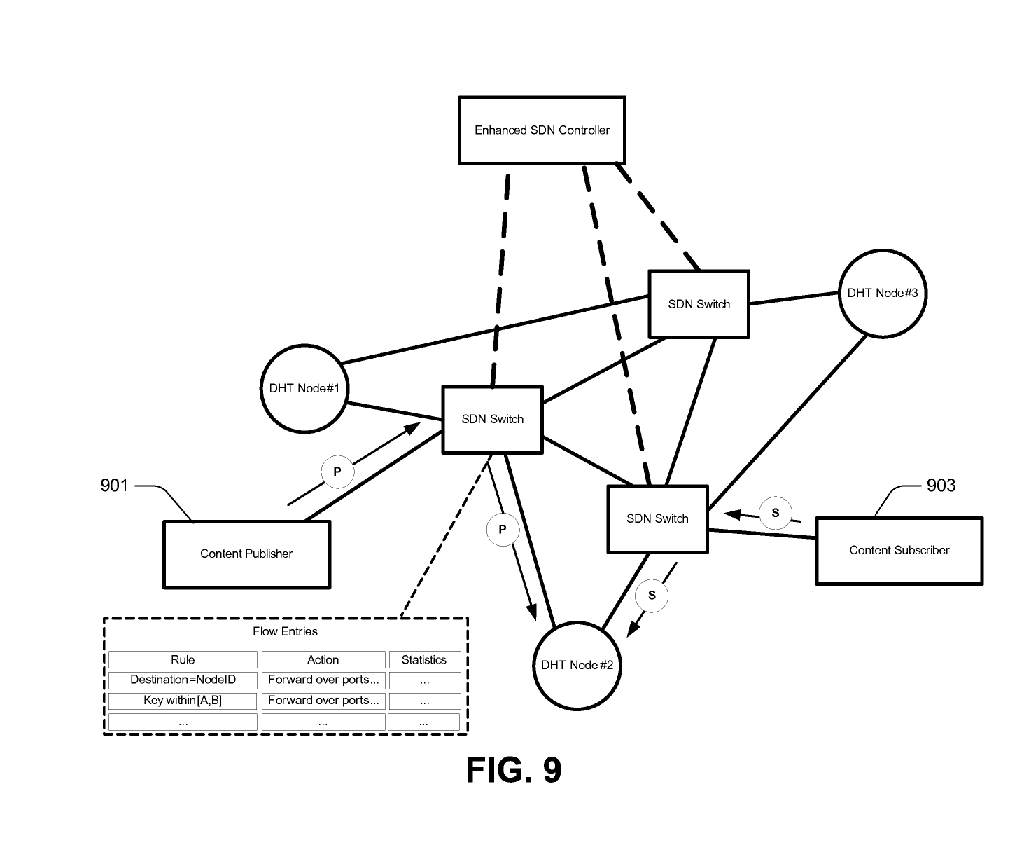

The method described above applies in the context of an ICN design using a DHT-based Name Resolution System distinct from the content routers infrastructure and that can be queried by any node, such as in Netlnf [4]. However, additionally any node may send a GET/SET message to the DHT-based NRS, not only the nodes that are members of the DHT. Therefore, the initial content requester or publisher may send a message toward the NRS, without the need to indicate a NRS entry point as a destination. FIG. 9 illustrates this point. In FIG. 9, “P” messages are publication requests, e.g., a Content Publish (e.g. 901) uploads into the NRS the content ID (or a key derived from this content ID) associated with its storage location; “S” messages are subscription requests, e.g., a Content Subscriber (e.g. 903) queries the NRS to obtain a locator pointing to an information object with a given content ID (or a key derived from this content ID). Note that content subscribers and publishers directly send DHT GET/SET messages over the network infrastructure nodes, typically without indicating a next hop (the sender can, for example, set as the destination IP address an anycast IP address). Even if a next hop is included in the message, it is not used by the SDN switches/routers when key-range based forwarding is in use. Content routing itself is not represented in FIG. 9. Only NRS usage signaling examples are shown, and further steps such as fetching the data object are omitted.

Also note that, in the Netlnf system [4], there may be multiple entangled DHTs, some of which may not be inside the same SDN domain. For those higher level DHTs (i.e., with a more global scope), an over-the-top DHT not making use of the present invention may be used; or alternatively, such multi-domain DHTs may be implemented in accordance with the embodiment described below in section 6.3.

6.2 Enabling SDN-Controlled Overlay DHTs

A second embodiment is suitable outside the scope of an ICN system and could apply to any DHT that is within a SDN domain. In particular, the system description of section 6.1.1 stands on its own and can be applied for any overlay DHT that is entirely contained within one SDN domain (and may be expanded to several domains as described in section 6.3). The present section adds further details to section 6.1.1. These overlay DHTs can be deployed over today's TCP/IP stack or can use another transport mechanism. Their implementation can be derived from existing DHT implementations such as Chord, Pastry, etc. As described in section 6.1.1, the adaptation of an existing DHT implementation comprises implementing the DHT Control part (including handling of node keep alive/join/leave and associated data migration) into a centralized entity (e.g., part of the SDN controller or a third party entity), and having DHT nodes communicate with this centralized entity using a simple API (e.g., including JOIN, LEAVE, DATA_TRANSFER and KEEP ALIVE messages). In particular, several independent overlay DHT networks can be supported in a same SDN domain by combining key-range matching with other information elements, such as an overlay DHT network ID. For example, the OpenFlow interface may be enhanced to add new fields “uint32_t_dht_id; /* DHT identifier. */” and “uint16_t dht_protocol; /* DHT protocol −0=Chord, 1=Pastry, etc. */” in the data structure described in 6.1.1. These information elements can be used by OF switches and routers to match packets depending on the particular DHT overlay network (and protocol) they belong to. Particular DHT protocols may need to be enhanced to support a network ID field to facilitate efficient identification by OF switches/routers.

Examples of DHT Control interface include the following messages:
JOIN (sent by DHT node to DHTCP) with fields including some or all of:
   DHT node locator (e.g., IP address)
   Possibly a DHT network identifier (if the DHTCP handles more than one DHT network)
JOIN Response (DHTCP to DHT Node):
   DHT node identifier in the DHT overlay network
   Some or all of DATA TRANSFER information elements
DATA_TRANSFER (DHTCP to DHT node):
   DHT node ID or locator of the destination or source of the transfer
   Range(s) of keys to transfer to/from the mentioned DHT node
LEAVE (DHT node to DHTCP):
   DHT Node locator and/or ID
KEEP_ALIVE (DHT node to DHTCP):
   DHT Node locator and/or ID
   Possibly the current key range(s) handled by this node

This can, for example, enable efficient implementation of multiple parallel naming services. Hence, rather than having one centralized naming resolution service such as today's DNS, there may be multiple naming services used in a competing or complementary fashion (e.g., one for each Information or Service Centric Network scheme supported in a network; e.g., one for each P2P overlay network).

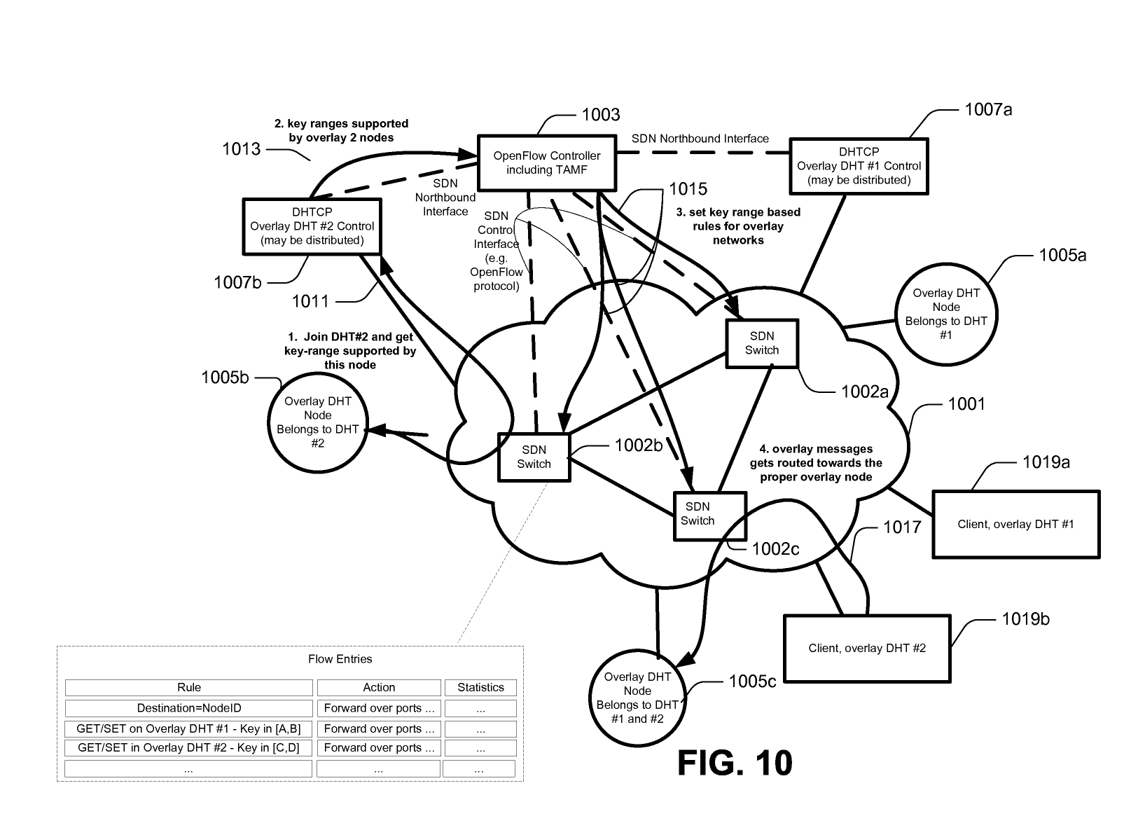

FIG. 10 illustrates how an SDN domain 1001 may support multiple overlay DHT networks and, more generally, structured peer-to-peer systems relying on hashing. Note that the control interfaces between the controller 1003 and the overlay nodes 1005a-1005c may be direct (i.e., DHTCP function is inside the SDN Controller), or, as shown in the diagram, indirect through an external DHTCP function 1007a, 1007b. In this exemplary network, DHT node 1005a is part of overlay DHT #1, DHT node 1005b is part of overlay DHT #2, and DHT node 1005c is part of both overlay DHTs #1 and #2. Also, note that DHT overlay networks #1 and #2 are handled through typically different flow entries inside the SDN switch/routers, for example, using a match on a “DHT overlay network identifier” information element found in data plane messages.

When an overlay DHT node, e.g., DHT node 1005b, joins overlay DHT #2, the first step is for it to send a JOIN DHT message to the DHTCP 1007b for overlay DHT #2, and receive its local key range from the DHTCP, collectively represented at 1011. Then, DHTCP 1007b updates the key ranges for the DHT nodes under its control (e.g., DHT nodes 1005b and 1005c) and sends messages (not shown) to the DHT nodes under its control (e.g., 1005b, 1005c) setting new range assignments. DHTCP 1007b also sends that same information to the SDN Controller 1003, as shown by message 1013. SDN Controller 1003 then determines updated key ranges for all of the DHT nodes in its domain, including DHT nodes 1005a-1005c for DHTs #1 and #2 and sends messages (1015) to the SDN switches 1002a, 1002b, 1002c setting new forwarding tables and rules for the overlay networks based on the new key range assignments.

When a client node, e.g., client node 1019b, issues a SET /GET request (message 1017), it is routed through the network to the appropriate DHT nodes 1005a-1005c and beyond as dictated by the new forwarding tables and rules.

If, as depicted, DHTCP 1007b is an external entity, the SDN northbound interface can include the message SET_KEY_RANGE 1013 as defined below. SET_KEY_RANGES
a. Destination DHT Node locator (or other ID)
b. Key range(s) associated with this DHT node
c. DHT network ID
d. Possibly additional information describing the DHT data plane protocol used, if several such protocols are supported

Note that, in this exemplary API, a DHTCP would send a single such message describing all key ranges toward a DHT node, which would overwrite any previous message related to this particular DHT node within this particular DHT network. Variants of this API may enable a more fine-grained control (e.g., add/update/remove messages).

In the opposite case, i.e., if DHTCP is implemented inside the SDN controller, then the “DHT Control API” described above will become the northbound interface (e.g., the DHT node can directly use the SDN northbound API in this case). Moreover, the DHTCP/SDN API described above (with SET_KEY_RANGE) becomes an internal interface in this case. Hence, one can summarize the SDN Controller role as:
In the non-collocated case, the SDN Controller implements low level function setting key-range based forwarding rules in the network. The advantage of this case is that it enables a larger range of users for this API, e.g., including multiple DHTCP supporting multiple DHT implementations (Chord, Pastry, etc.)
In the collocated case, the SDN Controller implements a high level DHT control plane function. The advantage of this embodiment is that, as part of the SDN controller, the DHTCP benefits from any fail-safe measures implemented for the SDN controller (e.g., redundancy).

6.3 Enabling SDN-Controlled DHT across Multiple Domains

Both in the context of DHT for ICNs (first embodiment) or in the more general case (second embodiment), one interesting use case is a DHT spanning several domains. Some or all individual domains may implement a SDN-controlled DHT as described herein.

6.3.1 Cooperative Multi-Domain SDN-Enabled DHT Case

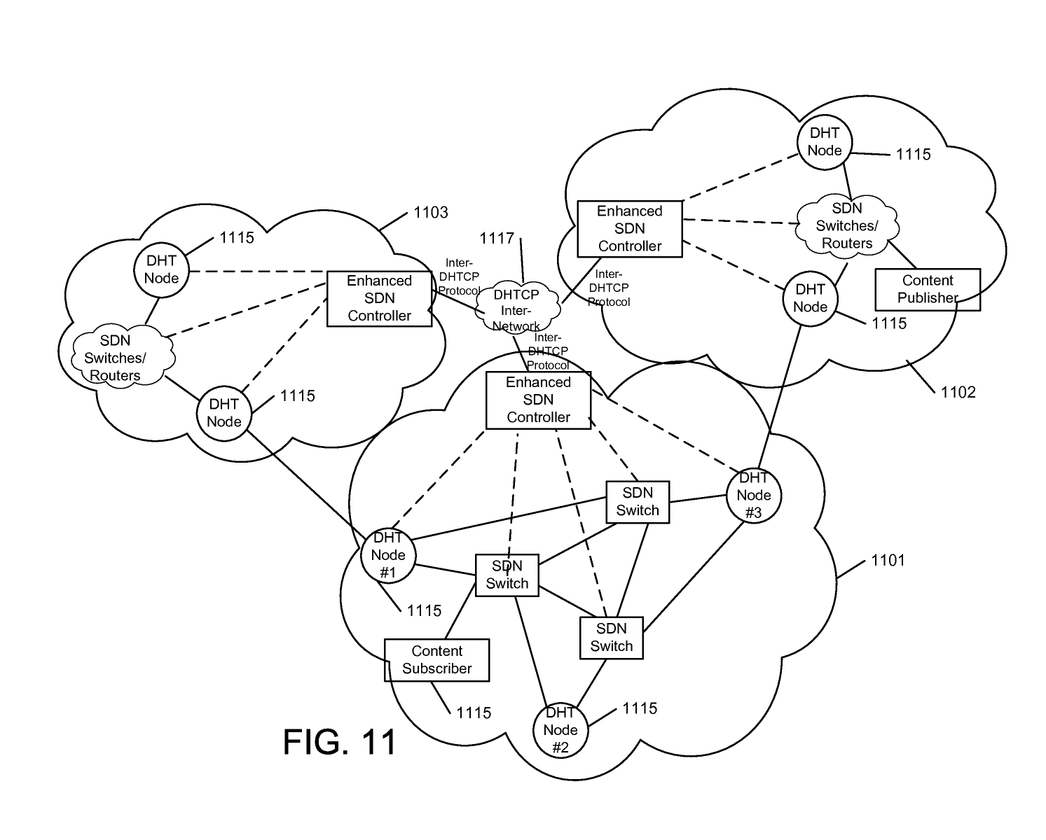

In a first “cooperative multi-domain SDN-enabled DHT” case, illustrated in FIG. 11, the DHT is entirely included inside a set of several cooperating SDN domains 1101, 1102, 1103. The DHTCPs 1111 of these domains are interconnected; this inter-network may, for example, follow a star, a full mesh, or a hierarchical tree topology. DHTCPs exchange DHT control information (e.g., the DHT routing table related to nodes inside their domains). DHTCPs can therefore configure their network to properly forward messages using key-range toward DHT nodes 1115 within their domain and toward border routers when responsible DHT nodes are outside of the domain. Border routers can be configured with key-range-based rules pointing to border routers from other domains. One simple implementation of this cooperative case is to have the DHT control performed by one single, master DHTCP 1117, and other DHTCPs 1111 used as relays for DHT control plane messaging between the DHT nodes 1115 in their domain and the “master” DHTCP. More complex distributed implementation can be developed also.

As in the single-domain case, DHTCP has the opportunity to optimize node ID allocation to maximize the opportunities for merging forwarding flow entries. One simple strategy is to partition the DHT ID space between domains, which makes it possible to forward DHT traffic toward all DHT nodes of a given domain typically with a single flow entry.

6.3.2 Hybrid Case

In a second, “hybrid” case, an SDN domain may internally control some of the DHT nodes while other DHTs nodes are outside of the domain. New border functions are introduced inside SDN domains, which are acting as proxies between the SDN-controlled DHT nodes and the outside DHT nodes. These border elements can forward DHT messages toward internal and external DHT IDs, as configured by the DHTCP. To enable this, the DHTCP can participate in the outside DHT on behalf of the inside nodes. DHTCP deals with control plane functions (including maintaining DHT routing tables) and inside DHT nodes deal with data plane functions. The border element forwards inward messages toward the DHTCP (control plane message) or DHT nodes (data plane messages). The border element performs some Network Address Translation (NAT)-like function or proxy function to outward messages in such a way that DHTCP messages related to one DHT node appear to be sent by this DHT node. From the outside DHT node's standpoint, inside DHT nodes implement the full DHT stack (i.e., border elements transparently divert some of the traffic to/from DHTCP).

In one optimized embodiment, the node ID allocation scheme may be designed to allocate a single partition of the ID space to certain domains (e.g., one per domain). This makes it possible to merge flow entries in DHT routing tables both inside SDN-controlled networks and in DHT nodes outside such networks. For example, all DHT nodes within a domain can be configured to use a given prefix in their node ID, where this prefix is permanently allocated to this domain.

### 7 ADDITIONAL DETAILS

7.1 Discussion on Hash Routing Control

Today, one way to implement hash-routing is to have a flow entry that redirects all packets of a certain type to the controller (e.g., all TCP SYN). The controller then calculates the hash value using certain field(s) from the packet, and checks an internal hash-routing table to determine how to process the packet (e.g., forward or drop). The controller can then configure a new flow for this particular TCP session.

This solution can become inefficient in cases where hash-routing is to be applied to a large number of packets. For example, in the case of ICN, every content request and/or response may be subject to hash-routing. In the particular case of CCN, there is a ratio of one request to one data packet, with typical data packet sizes of a few kilobytes, which leads to a very large number of content requests, and since there is no end-to-end transport session, it could become necessary to follow the simple method described above, i.e., to involve the controller for every single packet.

Today, there is no generic method to enable SDN-controlled hash-routing where the hash value calculation and forwarding decision is located inside the router/switch, without involving the controller.

7.2 Hash Routing Control (HRC) in SDN

Hash-routing comprises making a forwarding (or routing) decision based on a hash value. This hash value can be present in a field of an incoming packet or it can be calculated from information element(s) present in the incoming packet. Section 6 describes how a SDN controller can define a flow entry using a range of values on a particular field in the message. This can be generalized by enabling the SDN controller to configure the SDN router/switch to calculate a hash value from an incoming packet and then use this value to match a particular flow entry.

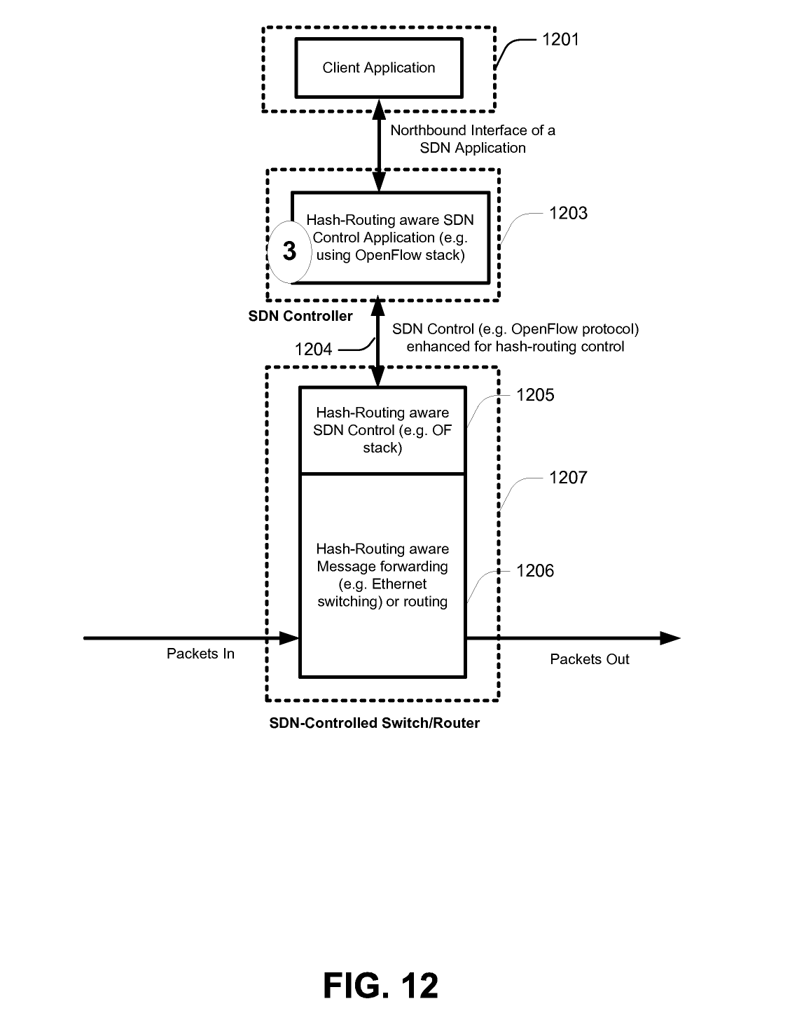

FIG. 12 is a block diagram of a Hash-Routing aware SDN stack according to an exemplary embodiment. The SDN Controller 3 may host a number of SDN applications, such as routing control, firewall, etc. Some of these applications may make use of hash-routing control (HRC) as described herein. The inner working of these HRC-aware SDN applications 3 as well as their North-Bound APIs 2 and their users 1 will be discussed again in section 7.3. In the present section, however, it is described as the user of the South-Bound API, i.e., how does the SDN controller interact with the HRC-aware SDN devices, whereas, in section 7.3, the focus is on the SDN application itself, i.e., how the SDN controller does implements the functions it makes available through its North-Bound API.

7.2.1 Enhancement of SDN Controller

The SDN Controller 3 first should discover the SDN-enabled network elements and interconnect with them for control. Once that phase is complete, the SDN Controller existing components, such as the IP routing SDN application, can configure the network as usual. Then, the HRC SDN Controller 3 obtains and possibly updates the HRC configuration of the routers/switches using the interface described in section 7.2.2.2. At this point, the SDN Controller 3 is aware of the HRC capabilities (i.e., support HRC and supported hash functions and hash input methods) available in each SDN device 1207. The SDN controller 1203 is now ready to accept North-Bound API commands from applications.

Some SDN router/switches 1207 may not be HRC aware. When adding a new HRC rule, the SDN Controller 3 should configure these non-HRC devices as needed to enable messages to be forwarded between HRC-enabled routers/switches. Therefore, typically, it is not necessary for the whole network to be HRC-aware to enable proper hash-routing control.

7.2.2 Enhancement of SDN South-Bound Interface

The HRC South-Bound Interface 1204 enhancement may be divided into two general aspects. First, the core of the interface enhancement comprises additional information elements describing the HRC flow entries for use in messages adding or otherwise controlling flow entries. Second, additional interface enhancements comprise new messages that enable control of the parameters of the core enhancement, including the hash function ID and hash input method ID.

7.2.2.1 Core HRC Enhancement Description

HRC is hereinbelow illustrated in a typical implementation of SDN, namely, OpenFlow, described in the OpenFlow specifications Error! Reference source not found. However, it should be understood that this is merely an exemplary embodiment and that this work may be applied to other Software Defined Networking approaches (such as FORCES for example).

While the primary HRC enhancements will be the HRC matching enhancements described later in this section, HRC is a capability that can be made known by the SDN device to the SDN controller during the existing OFPT_FEATURES_REQUEST/OFPT_FEATURES_REPLY message exchange, where the SDN controller requests information from the SDN device, and the device replies with a data structure ofp_switch_features, including its capabilities in a “capabilities” bitmap. Shown below in Table 3 is the OpenFlow ofp_capabilities bitmap showing an enhancement in the form of the last entry (underlined), i.e., the OFPC_HASH_ROUTING_CONTROL element that discloses the HRC capabilities, if any, of the device.

TABLE 3
/* Capabilities supported by the datapath. */
enum ofp_capabilities {
OFPC_FLOW_STATS = 1 << 0, /* Flow statistics. */
OFPC_TABLE_STATS = 1 << 1, /* Table statistics. */
OFPC_PORT_STATS = 1 << 2, /* Port statistics. */
OFPC_GROUP_STATS = 1 << 3, /* Group statistics. */
OFPC_IP_REASM = 1 << 5, /* Can reassemble IP fragments. */
OFPC_QUEUE_STATS = 1 << 6, /* Queue statistics. */
OFPC_ARP_MATCH_IP = 1 << 7 /* Match IP addresses in ARP pkts. */
OFPC_HASH_ROUTING_CONTROL = 1 << 8 /* HRC Support. */
};

In OpenFlow, the SDN controller can update the flow table in the SDN switch/router 7 using a “Modify Flow Entry” Message. This message includes the ofp_match data structure, which describes how a packet matches this particular flow entry.

An enhanced embodiment of the ofp_match data structure in OpenFlow is shown below in Table 4. Particularly, the ofp_match data structure (part of an “Enhanced Modify Flow Entry” message) may be enhanced to include hash routing specific information elements. This enhancement may include adding the number of hash routing descriptors that are also present in the message, seen below as the new unint8_t num_hash_routing_descriptors entry (underlined). In the general case, when there is no hash routing specified in a command, there is no additional data. If there is (typically one) hash routing component in the flow description, the field is set to 1 and the additional hash routing information is carried in a second data structure in the same message.

TABLE 4
/* Fields to match against flows */
struct ofp_match {
uint16_t type; /* One of OFPMT_* */
uint16_t length; /* Length of ofp_match */
uint32_t in_port; /* Input switch port. */
uint32_t wildcards; /* Wildcard fields. */
uint8_t dl_src[OFP_ETH_ALEN]; /* Ethernet source address. */
uint8_t dl_src_mask[OFP_ETH_ALEN]; /* Ethernet source address mask. */
uint8_t dl_dst[OFP_ETH_ALEN]; /* Ethernet destination address. */
uint8_t dl_dst_mask[OFP_ETH_ALEN]; /* Ethernet destination
address mask. */
uint16_t dl_vlan; /* Input VLAN id. */
uint8_t dl_vlan_pcp; /* Input VLAN priority. */
uint8_t pad1[1]; /* Align to 32-bits */
uint16_t dl_type; /* Ethernet frame type. */
uint8_t nw_tos; /* IP ToS (actually DSCP field, 6 bits). */
uint8_t nw_proto; /* IP protocol or lower 8 bits of ARP opcode. */
uint32_t nw_src; /* IP source address. */
uint32_t nw_src_mask; /* IP source address mask. */
uint32_t nw_dst; /* IP destination address. */
uint32_t nw_dst_mask; /* IP destination address mask. */
uint16_t tp_src; /* TCP/UDP/SCTP source port. */
uint16_t tp_dst; /* TCP/UDP/SCTP destination port. */
uint32_t mpls_label; /* MPLS label. */
uint8_t mpls_tc; /* MPLS TC. */
unint8_t num_hash_routin_descriptors; /* Number of hash routing
description entries included in structure */
uint8_t pad2[2]; /* Align to 64-bits */
uint64_t metadata; /* Metadata passed between tables. */
uint64_t metadata_mask; /* Mask for metadata. */
};

An OpenFlow message carrying ofp_match with a non-zero n=num_hash_routing_descriptors will also carry n new data structure ofp_hash_routing_descriptors, as shown below in Table 5:

TABLE 5
struct ofp_hash_routing_descriptors {
struct ofp_hash_function_specification hash_function_specification;
struct ofp_hash_input_specification hash_input_specification;
struct ofp_range_specification range_specification;
};

In the structures above, hash_input_specification designates which method is used by the SDN device to extract the hash function input from an incoming message, and hash_function_specification designates how the hash function is calculated based on this input to generate a hash value. Range_specification completes the set of parameters that is needed for the SDN device and specifies the range of hash values to take a hash-routing match decision. Exemplary embodiments of the data structures of these three descriptors are shown below in Table 6.

TABLE 6
struct ofp_hash_function_specification {
uint_32t hash_function_id;
uint32t size;
/* other hash function parameters may be added here */
};
struct ofp_hash_input_specification {
uint_32t hash_input_id;
/* certain hash input methods may require parameters, which
can be added here */
};
struct ofp_range_specification {
/* this example uses 32bit values - if the hash value space is larger,
it may still use the same range specification and consider
that the min and max values specified are the most significant
bits of the actual min and max hash values, setting the least
significant bits to 0 for the min value and 1 for the max value. */
uint32t min_value_included;
uint32t max_value_included;
};

The data structures above carry certain identifiers that need to be pre-agreed upon between the SDN controller and the SDN device:
hash_function_id can be obtained from ListSupportedHashFunctions( ) described in section 7.2.2.2
hash_input_id can be obtained from ListSupportedHashFunctionInputs( ) also described in section 7.2.2.2
7.2.2.2 HRC-Support enhancement description

As described above, the controller 1203 and the device 1207 should agree on certain IDs used to specify an HRC flow entry. Typically, the device has a pre-configured list of supported hash function methods and input methods, which are fixed for a given version of the software. While it is possible to extend OpenFlow to enable transmitting this information, it may be more appropriate to use a network configuration protocol for this type of operation, e.g., network configuration protocols such as NetConf, SNMP, or RESTConf. The following REST-based API model may be implemented using RESTConf, for example:
ListSupportedHashFunctions( )returns a document (e.g., XML or JSON encoded) listing descriptions of one or more hash functions which are supported by the device. The hash function description may include a well-known string describing the hash function type, such as “MurmurHash3”, or “FNV-la” as well as parameters, such as the hash size, or other parameters dependent on the hash function type.
   Example:

TABLE 7
Req: POST /hrc /list-supported-hash-functions
(empty body)
Rsp: 200 OK (or another code in case of failure)
{ “hash-functions”: [
{ “id”:1, “name”: “MurmurHash3”, “params”: { “size”: [ 32, 64, 128 ] },
{ “id”:2, “name”: “FNV-1a”, “params”: { “size”: [ 32, 64, 128, 256 ] },
] }

ListSupportedHashFunctionlnputs( )returns a document (e.g., XML or JSON encoded) listing the description of one or more hash function input methods that are supported by the device 7. This description includes an ID, e.g., a number sequentially generated by the SDN controller or a unique string ID generated by the SDN controller (unique among other function input IDs generated by this controller). This ID can later be used to designate a particular method of determining the input to the hash function. The actual description of the input method should include information such as protocol and header field name.
   Example:

TABLE 8
Req: POST /hrc /list-supported-hash-function-inputs
(empty body)
Rsp: 200 OK (or another code in case of failure)
{
“hash-function-inputs”: [
{ “id1”: “ccn-name”, “protocol”: “ccn/1.0”, “field”: “Content-name” },
{“id2”: “ipv4-addr”, “protocol”: “ipv4”, “field”: “Destination-Address” },
{“id3”: “http-uri”, “protocol”: “http/1.1”, “field”: “Destination-Address”}
] }

In a more elaborate setting, the SDN device could offer a finer grained configuration of possible input methods. For example, again using NetConf/SNMP/RESTConf protocol, the SDN Controller could set a desired input method by specifying a combination of protocols (among a list of possible protocols recognized by the device) and field identifiers (among a list of possible protocol header fields recognized by the device). The SDN device would then store the desired input method along with a unique ID, and return this ID to the controller.

As discussed above in section 7.1, cases like Hash-Routing on HTTP URI over TCP can be implemented without HRC using the controller. Nevertheless, HRC still may be used in this case. Upon match, the SDN device could, in this case, insert a new flow entry for the TCP flow over which the match was detected.

7.2.3 Enhancement of Control Function in a SDN-Controlled Switch/Router

The control function of the switch/router 1207 implements the following logic: (1) receiving SDN South-Bound Interface messages from the SDN controller, enhanced with hash-routing information elements and (2) updating the flow table based on this input.

The control function 1205 is therefore updated to process HRC South-Bound commands, such as the Enhanced Modify Flow Entry message. This processing extracts the fields from the control message and populates the flow table structure. The format of a flow entry may be enhanced as shown below in Table 9 (in which new fields are indicated in underlining and existing information elements taken from the OpenFlow specifications Error! Reference source not found.are indicated without underlining).

TABLE 9

| Flow Entry | | |
|---|---|---|
| Component | Usage | Description |
| Match fields | Used as parameters | Existing match fields include Ingress |
| | to determine if a | port, Ethernet source, VLAN Id, |
| | packet matches | IPv4 destination, etc. |
| | this particular | HRC-Enhancements: |
| | flow entry | A number N of “Hash Routing |
| | | Match Descriptor” (0 for non- |
| | | hash-routing flows, 1 or more |
| | | for hash-routing flows). |
| | | N “Hash Routing Match |
| | | Descriptor” data structure (see |
| | | Tables 5 and 6 in section |
| | | 7.2.2.1 above), which includes |
| | | a description of the hash |
| | | function, input method, |
| | | and range. |
| Counters | Used to maintain | (No change needed to the counters |
| | statistics | to support HRC: the counters are |
| | | further described in the OpenFlow |
| | | specifications Error! Reference |
| | | source not found..)) |
| Instructions | Used to modify | (No change needed to the instruc- |
| | the action set or | tions to support HRC: instructions |
| | pipeline processing. | are further described in the |
| | | OpenFlow specifications Error! |
| | | Reference source not found..) |

Additionally, the Control Function 1206 of the SDN Switch/Router 1207 should enable the other south-bound API functions, such as the advertisement of the supported hash functions/input types/range specifications. For hash functions and input types, the forwarding engine implementation (which may not be extensible because of efficiency reason, e.g., performed in hardware) may limit the actual hash functions and input types that are available. Typically, the forwarding engine may implement a single range specification method and the switch control function can perform the conversion between multiple range specification methods made available over the South-Bound interface and the single range specification implemented in the engine.

7.2.4 Enhancement of Forwarding Function in SDN-Controlled Switch/Router

Currently, the forwarding function of a SDN Switch/Router comprises selecting flow entries based on matching rules (exact value match). HRC-support should enhance the forwarding function to support packet matching based on the new HRC-enhanced flow entry described in Table 9 above:
as before, one or more exact value match (e.g., IP protocol ID match);
locating one or more fields specified in the flow entry;
applying a hash function (also specified in the flow entry) to it;
Matching this hash value with a range specified in the flow entry.

OpenFlow already supports defining multiple flow tables and flow entry points to other flow tables. Therefore, a possible way to implement hash-routing is to use a first non-hash-routing flow entry in a first table as an entry point to a second flow table containing several hash-routing entries. For example, the first flow entry can match all packets with a destination IP address set to a certain anycast address. The second flow table can then contain multiple similar flow entries that differ primarily by their range and forwarding action, but which typically share the same hash function and input method. Furthermore, one important design consideration for the forwarding engine is that it should enable line-speed operation. For example, hash function calculation and range matching may be implemented entirely or partially in hardware. Another speed optimization feature may be to cache recently calculated hash values in such a way that packets belonging to the same flow will not in general result in the same hash value being calculated multiple times.

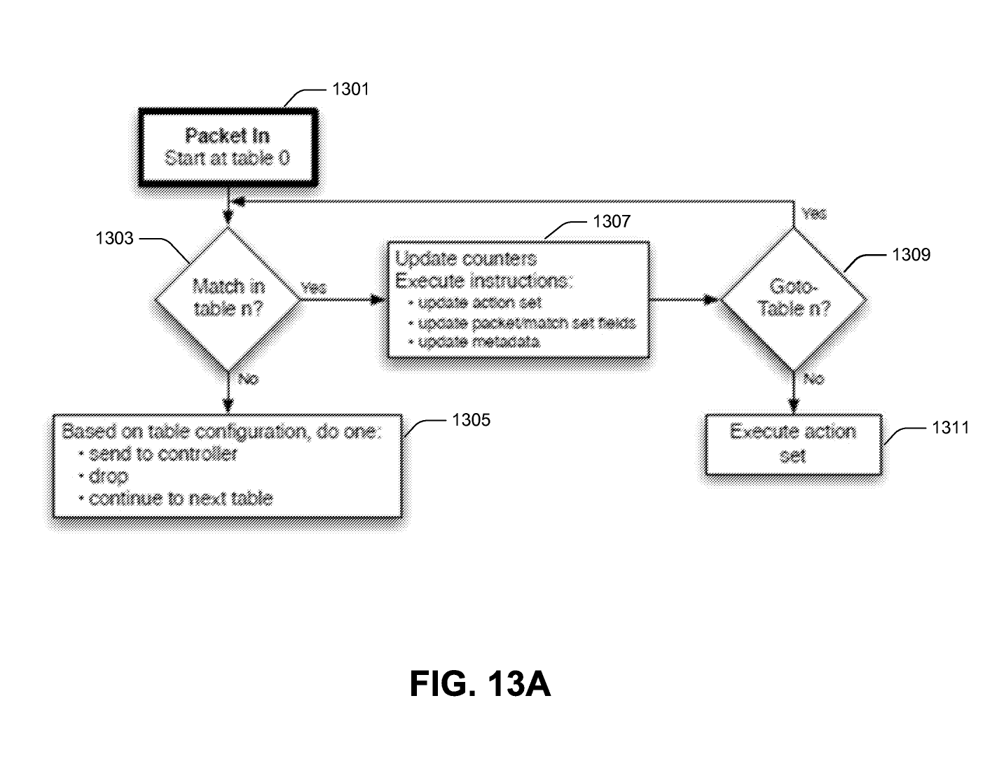

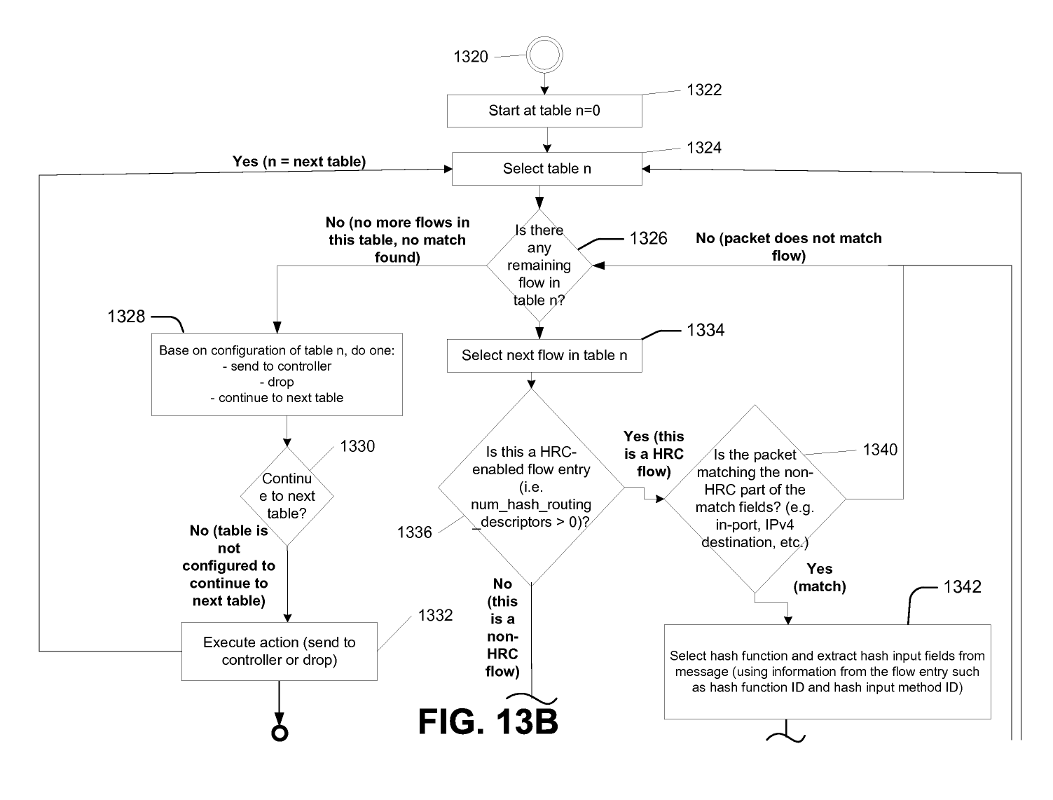

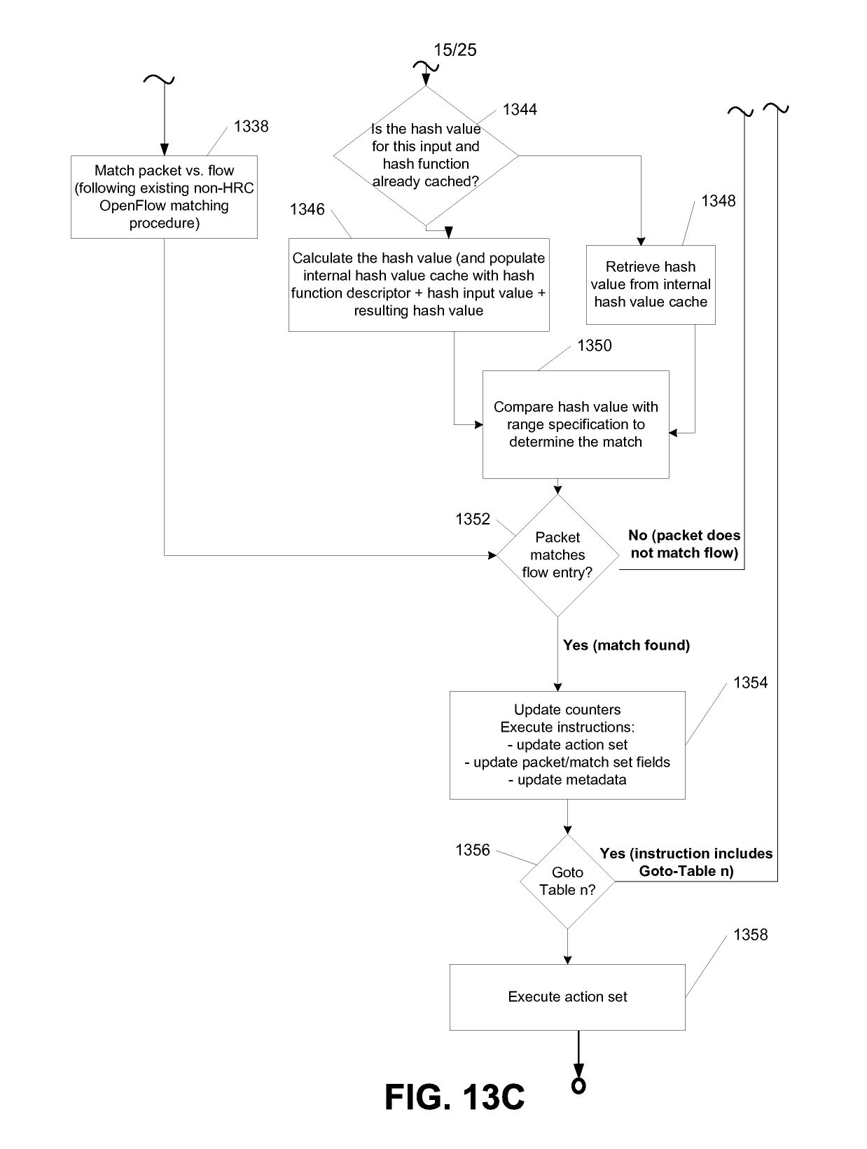

FIG. 13A illustrates a conventional packet processing flowchart through an OpenFlow switch, while FIGS. 13B and 13C collectively illustrate a HRC-enhanced version of this process in accordance with one exemplary embodiment. Referring to FIG. 13A, a packet is received at 1301 (and it starts at table 0). At step 1303, the switch determines if there is a flow entry in the current table that matches the necessary parameters set forth in the ofp_match fields of the packet. If not, the switch will send the packet to the controller, drop the packet, or continue on to check for a match in the next table (step 1305). If, on the other hand there is a match, it will update the relevant counters and execute the instructions (at step 1307), which may include updating (but not yet executing) the action set, updating any packet/match set fields, and updating any metadata. As noted above, the action set may indicate an entry point into another table. Thus, in decision step 1309, if the action set includes a lead to another table, the switch enters that other table and repeats the process. If, on the other hand, the action set does not include an entry point into another table, the switch executes the action set at 1311.

In accordance with one embodiment as shown in FIGS. 13B and 13C (which collectively form one flow diagram), this operation is enhanced to accommodate HRC. As before, when a packet arrives at the switch (step 1320), it starts at table 0 (step 1322) and selects the table (step 1324). In decision step 1326, if there are no more flow entries in this table to check, flow proceeds through steps 1328, 1330, and/or 1332, which are largely similar to steps 1307, 1309, and 1311 discussed in connection with FIG. 13A. That is, if there is a match, it will update the relevant counters and execute the instructions (step 1328), which may include updating (but not yet executing) the action set, updating any packet/match set fields, and updating any metadata. As noted above, the action set may indicate an entry point into another table. Thus, in decision step 1330, if the action set includes a lead to another table, the switch enters that other table and repeats the process. If, on the other hand, the action set does not include an entry point into another table, the switch executes the action set at 1332.

Otherwise, flow proceeds from decision step 1326 to step 1334 to select the next flow entry in the table. Then it determines if that flow entry is an HRC-enabled flow entry (step 1336). If not, flow proceeds largely as described above in connection with FIG. 13A to determine if the match parameters in the packet match those of the flow entry (1338). On the other hand, if the flow entry is an HRC enabled flow entry, the process proceeds to step 1340 1340, 1342, and 1344 largely as described above in connection with FIG. 13A.

On the other hand, if it is an HRC-enabled flow entry, flow instead proceeds from decision step 1336 to step 1340, where it is determined if the packet match parameters match those of the flow entry. If not, flow proceeds back to step 1326 to start the process again for the next flow entry in the table. If so, flow instead proceeds to step 1342 where the switch determines the hash function and extracts the hash input fields using the algorithms dictated in the flow entry. Next, in step 1344, it checks to see if it already has a cached copy of the hash value for the matching and hash function and inputs. If so, it retrieves the hash value (step 1348). If not, it calculates the hash value using the identified hash function (step 1346). In either event, next, in step 1350, it checks if the hash value is within the range of (key; value) pairs stored at this switch. If so, it proceeds through steps 1352, 1354, and 1356, which are substantially the same as steps 1303, 1307, and 1309 in FIG. 13A. Particularly, at 1352, the switch determines if the flow entry in the current table matches the necessary parameters set forth in the ofp_match fields of the packet header. If not, flow returns to step 1326 to try another flow entry in the table (if any remain untried). If, instead, a match is detected in step 1326, processing proceeds to step 1354 where it will update the relevant counters and execute the instructions (which may include updating, but not yet executing, the action set), update any packet/match set fields, and update any metadata. As noted above, the action set may indicate an entry point into another table. Thus, next, in decision step 1356, it determines if the action set includes a lead to another table. If so, flow returns to step 1324 and the switch enters that other table and repeats the process. If, on the other hand, the action set does not include an entry point into another table, flow proceeds from step 1356 to step 1358, where the switch executes the action set.

7.2.5 Exemplary Embodiment

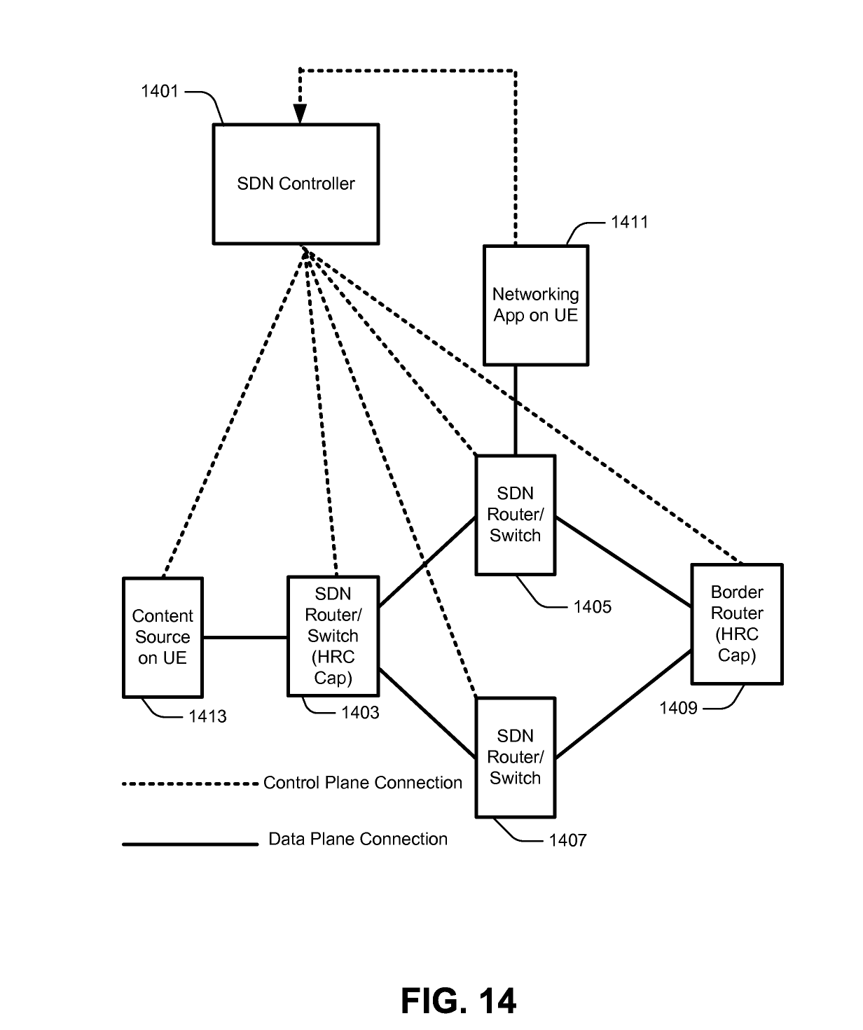

For this exemplary embodiment, the topology shown in FIG. 14 is assumed. Control plane communications are represented by dotted lines, while data plane communications are represented by solid lines. An SDN controller 1401 oversees four SDN routers/switches 1403, 1405, 1407, and 1409.

In this example network, UE 1411 is running a networking application that makes use of a HRC-aware SDN Application implemented in the SDN controller 1401. To illustrate the most general case, further assume that only a subset of the SDN devices is HRC capable (here, only router 1403 and border router 1409 are HRC capable). No assumptions are made on the nature of the HRC-aware SDN application. In this example, the SDN application on UE 1411 decides to split CCN traffic into two flows, one through router 1405 and one through router 1407.

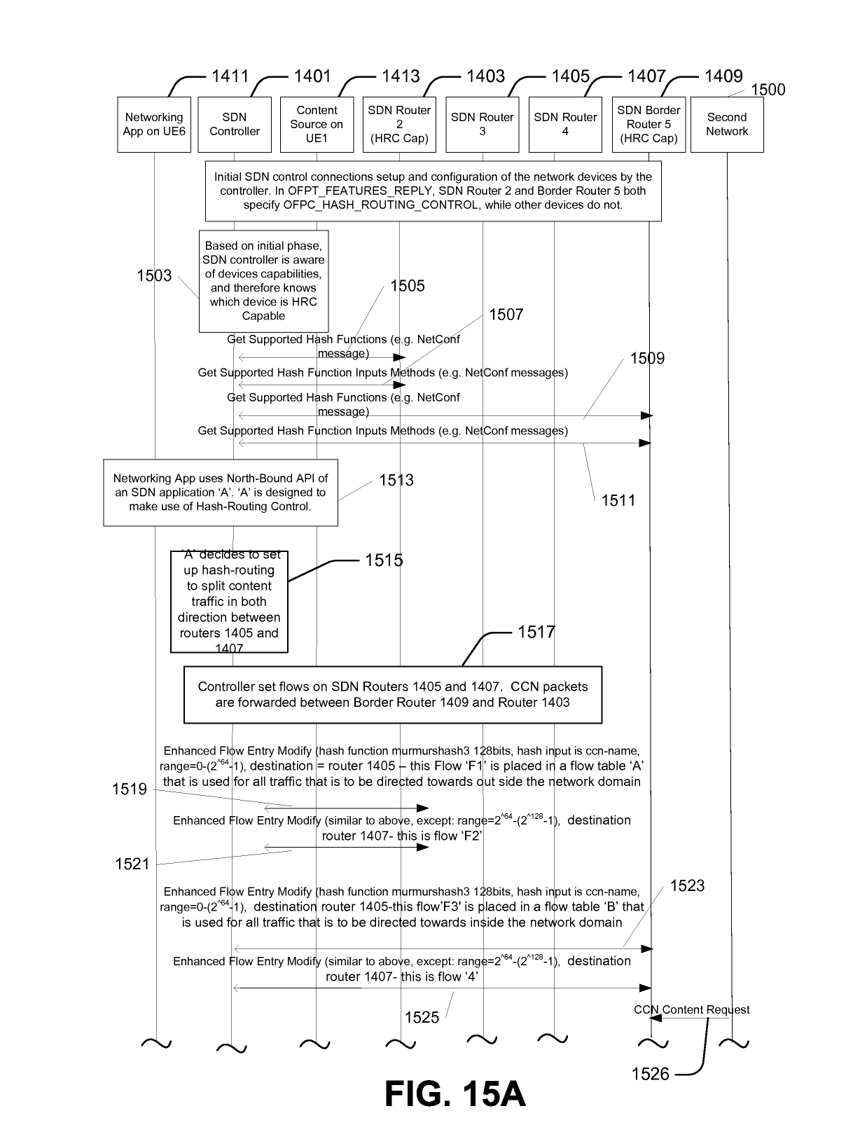

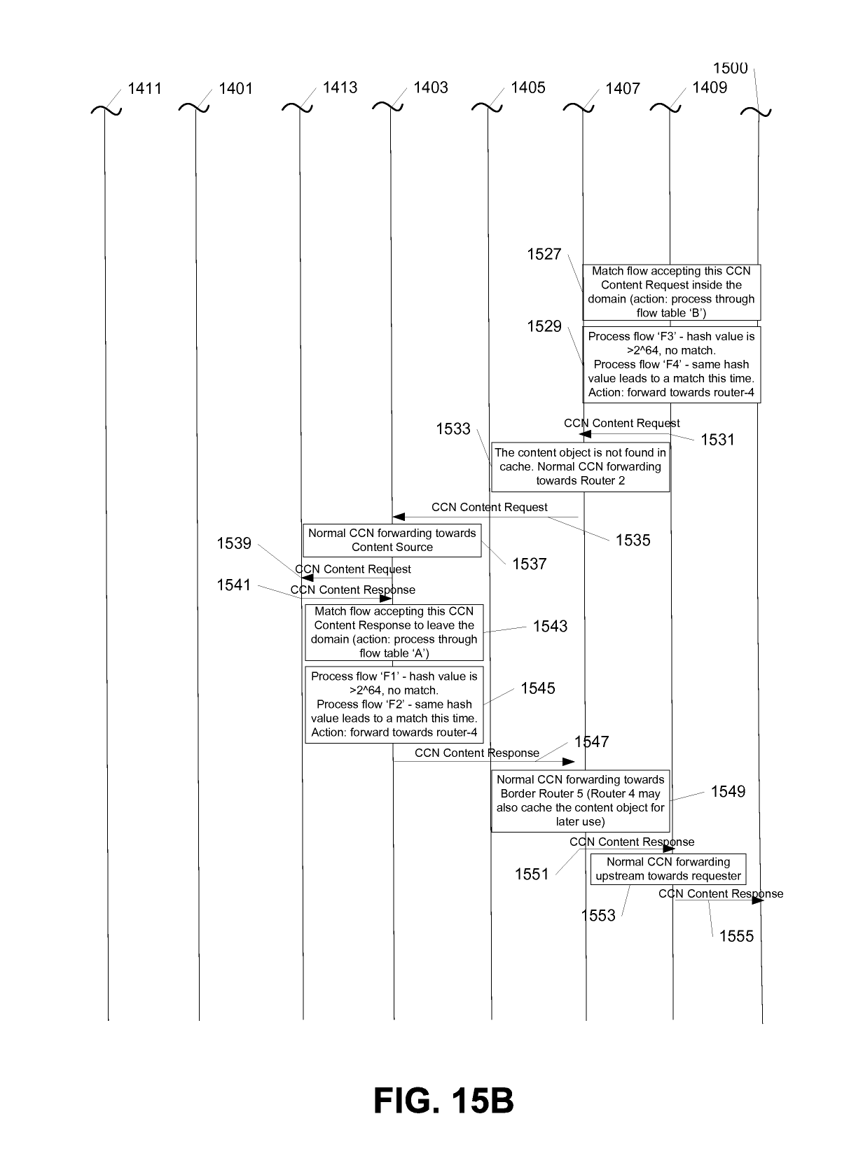

FIGS. 15A and 15B collectively form a message flow diagram illustrating Hash-routing control message flow for the example topology of FIG. 14. Initially at 1501, the SDN controller 1401 initializes the control plane connections with the switches/routers 1403, 1405, 1407, 1409 and configures them. Thus, as shown at 1503, the SDN Controller 1401 knows the capabilities of the switches/routers and, hence, knows that routers 1403 and 1409 are HRC capable.

Hence, as shown by signal flows 1505, 1507, 1509, and 1511, the SDN Controller 1401 requests (and receives) the Hash functions and Hash function inputs from each of the HRC capable routers 1403 and 1409. (Note that the double arrowed lines with one full arrow at one end and one line arrow at the opposite end represent a request (the full arrow) and the response thereto (the line arrow).

Next at 1513, the networking application on UE 1411 makes use of a HRC-aware SDN Application, A, implemented in the SDN controller 1401. The nature of application A is not relevant. For example, it may be a DHT Control Plane application running on the SDN Controller. It also may be any other SDN application that makes use of hash routing, such as a load balancing SDN application. In that case, the Networking App on UE 1411 may, for example, configure the SDN load balancing application to divide the load equally between two caches. At 1515, application A in SDN Controller 1401 decides to set up hash routing to split the content between UE 1413 and 1411 in both directions between routers 1405 and 1407 for load balancing purposes. So, at 1517, SDN Controller 1401 sets flows on SDN routers 1405 and 1407 to forward CCN packets between border router 1409 and router 1403. Next, as shown at 1519, the controller 1401 first configures the flow table in HRC capable router 1403 with a flow entry F1 that will forward name resolution packets in a first range to router 1405 for all traffic that is headed outside of the network. Similarly, as shown at 1211, the Controller 1401 also configures router 1405 with a flow entry F2 that will forward name resolution packets in a second range to router 1407. Alternately, both flow entries could be sent in a single message.

Next, as shown at 1523 and 1525, Controller 1401 similarly configures the flow table of HRC capable router 1409 with flow entries F3 and F4 for forwarding name resolution requests in the first range to router 1405 and name resolution requests in the second range to router 1407.

Another network 1500 issues a CCN request 1526 to the border router to which it has access, router 1409, for content that is located at UE 1413 (although the request does not identify the content by its location). In step 1527, router 1409 processes the key in the request through the first table and finds a match to a flow in the table. That flow typically matches incoming content requests for content available locally, and indicates that the request should be processed through a different table, table B. Then, router 1409 looks in flow table B and finds a match with entry F4 for the range within which the CCN request falls (step 1529). Thus, it forwards the CCN request to router 1407 as shown at 1531. Router 1407 determines that the requested content object is not found in its cache (step 1533) and forwards the request towards router 1403 (step 1535). Router 1403 determines that the requested content is in UE 1411 (step 1537) and forwards the request to UE 1411 (step/message 1539). UE 1411 returns the request content object to router 1403 (step/message 1541).

Next, at step 1543, router 1403 matches the CCN content response to a flow in its flow table. This flow typically matches outgoing responses to requests for content available locally, and indicates that the response should be processed through table A. Then, in step 1545, router 1403 processes the key through table A and finds a match for the CCN response in flow F2 of flow table A and, therefore, forwards the request as dictated by flow entry F2, ie., to router 1407 (step/message 1547).

Router 1407, which is not an HRC capable router, determines that it should forward the response to router 1409 (it also may cache the content for future use), as shown at step/message 1549. Next, HRC capable router 1409 determines that it should forward the content response to the other network 1500 (step 1553) and performs a conventional CCN forwarding of the content to the other network 1500 (step 1555).

In the above-described embodiment, the SDN device needs to calculate the hash function as part of every flow matching (as long as this flow includes a hash routing matching descriptor). As an optimization, the result of such a calculation may be cached. Therefore, even if the flow table has multiple flows using the same hash function and hash function input field, but with a different range, then only one hash value will need to be calculated for the first flow. Then, subsequent flows matching operations will reuse this value. Consequently, this embodiment should not require unnecessary processing.

7.3 Hash Routing Control (HRC) in SDN—Alternate Embodiment

The embodiment described in the previous section requires a relatively complex structure (hash routing match descriptor) to be included in the definition of a flow. Thus, while that embodiment is a practical one, there are other embodiments that require less intrusive changes to the OpenFlow protocol.

OpenFlow protocol supports a so-called “Apply-Action” instruction. When a packet matches a flow with an “Apply-Action” instruction configured, the switch will immediately execute the action specified by the instruction. The actions are those defined in the OpenFlow protocol, e.g., Push a new VLAN tag.

An alternative embodiment of HRC in SDN utilizes and enhances such “Apply-Action” instruction to simplify the definition of HRC-related flows. The key ideas of this alternative solution include:
1) Defining a new action called “HRC-FUNCTION”, which can be used by the “Apply-Action” instruction to process specific HRC functions (this function is configured by the controller using some pre-defined building blocks provided by the SDN device);
2) Creating flow entries that cause packets that need to be hashed to be processed through such a HRC function using this new HRC-FUNCTION action.
3) Creating flow entries that match the output of such a HRC function against a range of acceptable values, and apply actions on matching packets.

In accordance with the embodiment, flow entries are created to send hashed packets to their routing destinations using the output of the HRC-FUNCTION action. The “HRC-FUNCTION” action may have several parameters, such as: a function ID, a Table ID, and, possibly, a metadata mask. This action triggers the calculation of a function from the input packet and sets the result of the function as metadata (possibly using the metadata mask to delimit which part of the metadata will be updated with the function output). Note that a storage location other than the existing metadata field could be used, e.g., a dedicated new metadata information element. Nevertheless, this embodiment still is likely less disruptive to the existing OpenFlow specifications than the previous embodiment.

Presently, the metadata field length is 64-bits. If the function output is larger than 64 bits (or larger than the specified mask), then, typically, only the most significant bits of the function output will be copied over. Then the packet is processed through the table specified in the Table ID part of the action. Note that such Table ID is also optional to the “HRC-FUNCTION” action because a “Write-Action: Table ID” instruction would have the same effect of redirecting the hashed packets to the flow table with Table ID. With that being said, the Table ID parameter does keep the first flow table simple and “HRC-FUNCTION” action independent. The function ID identifies the actual function to be used. This function can be pre-defined by the SDN device and/or configured by the SDN controller using a configuration API. Such configuration includes the input field(s), e.g., the destination IP address, a content name in a CCN request. The SDN device and OpenFlow protocol are therefore enhanced to support an Enhanced Modify Flow Entry message. The format of a flow entry (both in the OpenFlow protocol and in the internal flow representation in the SDN device) is enhanced as shown below in Table 10 (new fields are indicated with underlining and existing information elements are taken from the OpenFlow specifications Error! Reference source not found.).

TABLE 10

| Flow Entry | | |
|---|---|---|
| Component: | Usage | Description |
| Match fields | Used as | Only change needed here to support |
| | parameters to | HRC, is a new range specification |
| | determine if a | for metadata: |
| | packet matches | HRC-Enhancements: |
| | this particular | Additional fields in ofp_match: |
| | flow entry | Unint64_t metadata_min; /* minimum |
| | | value of metadata (included) */ |
| | | Uint64_t metadata_max; /* maximum |
| | | value of metadata (included) */ |
| Counters | Used to | (No changes needed to the counters |
| | maintain | tos upport HRC, further described in |
| | statistics | the OpenFlow specifications Error! |
| | | Reference source not found..)) |
| Instructions | Used to modify | Only change needed here to support |
| | the action set | HRC, is a new action supported by |
| | or pipeline | Apply-Actions: |
| | processing. | HRC-Enhancements: |
| | | New action “ HRC-FUNCTION” |
| | | supported by “Apply-Action” |
| | | instruction. |
| | | FUNCTION action parameters: |
| | | Function ID |
| | | Next Table ID |
| | | Metadata mask |

7.3.1 Example of Application of the Alternate Embodiment of HRC in SDN

Prior to configuring the flows, the SDN Controller uses NetConf to configure function ID #0 to use the MurmurHash3 hash function, and to use the CCNx content name field as input. The previous section already discussed how the SDN controller can obtain support hash functions and input methods (see ListSupportedHashFunctions( )and ListSupportedHashFunctionlnputs( )above). An additional NetConf command is proposed to enable the SDN controller to configure the hash function in the SDN device. Table 11 below shows an exemplary ConfigureHashFunction( )configuration API function.

TABLE 11
Req (sent by SDN controller): POST /hrc/configure-hash-function
{ “function-id”: 0,
“hash-function”: { “name”: “MurmurHash3”, “params”: { “size”: 64 },
“hash-function-input”: { “id”: “ccn-name } }
Rsp (sent by SDN device): 200 OK (or another code in case of failure)

Table 12 below shows two flow tables of an exemplary embodiment in accordance with this alternative. Note that the two flow tables, Table 0 and Table 23, can be configured as two parts of a single table in a database.

```
TABLE 12
Table 0
Flow 1..n-1: normal (non-HRC) flows
Flow n:
  Matching fields: UDP port x known by operator to be used by CCNx and
  destination IP address is IP block known by operator to be CCNx routers.
  Counters
  Instruction: Apply-Action “HRC-Function”, function-id=0
  (MurmurHash3), Table 23, metadata mask=0xFFFFFFFFFFFFFFFF
  (all ones on the 64bits)
Table 23
Flow 1:
  Matching fields: (new fields) minimum and maximum values for
  metadata are specified in the ofp_match data structure: min=0,
  max=0x7FFFFFFFFFFFFFFF
  Counters
  Instruction: Apply-Action “Output” over port #0
Flow 2:
  Matching fields: (new fields) minimum and maximum values for metadata
  are specified in the ofp_match data structure: min=0x8000000000000000,
  max=0xFFFFFFFFFFFFFFFF
  Counters
  Instruction: Apply-Action “Output” over port #1
```

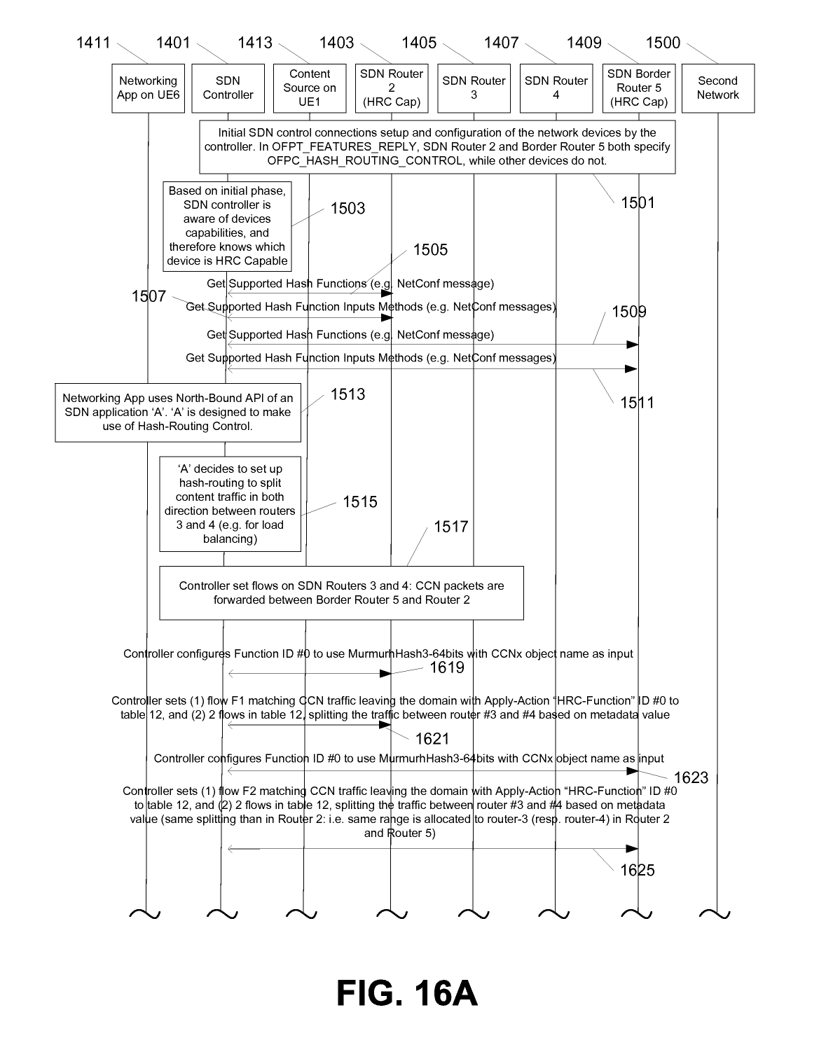

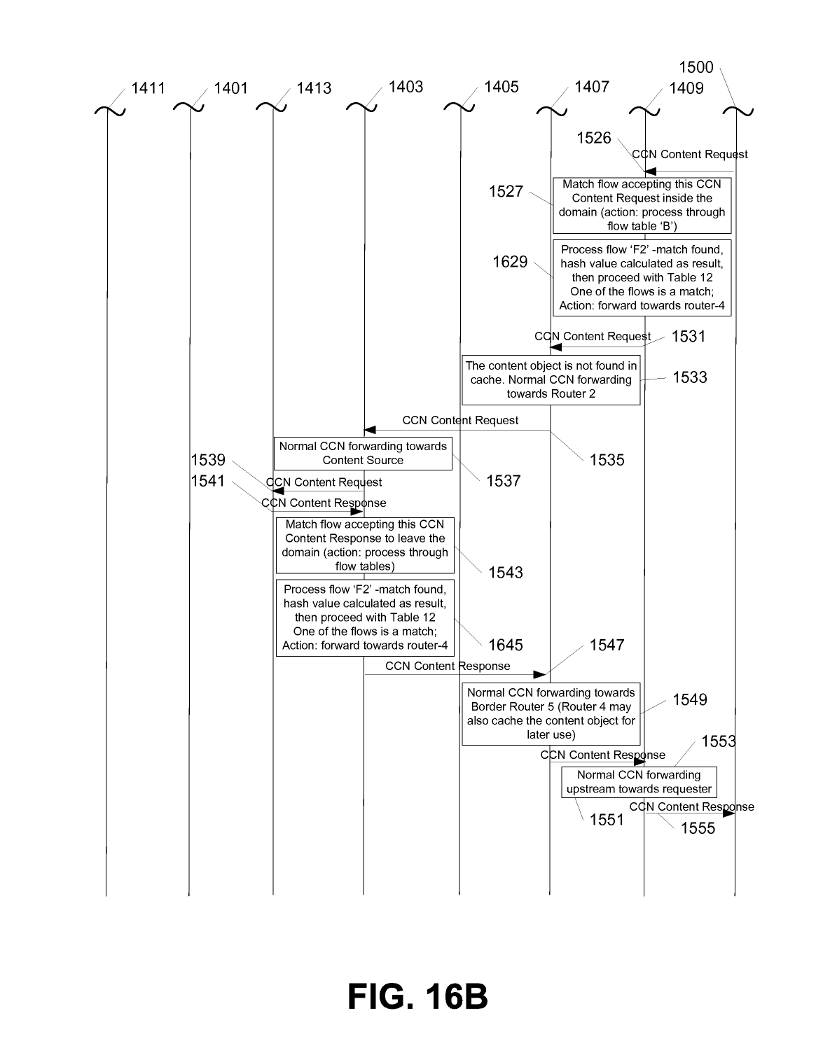

FIGS. 16A and 16B collectively form a message flow diagram showing Hash-Routing control message flow in accordance with this exemplary embodiment. Only the differences from the embodiment illustrated in FIGS. 15A and 15B are discussed in detail herein. As shown, all steps/messages are the same in the embodiment of FIGS. 16A and 16B (and are labelled with the same reference numerals) except that steps/messages 1519, 1521, 1523, 1525, 1529, and 1545 are replaced with steps 1619, 1621, 1623, 1625, 1629, and 1645, respectively. With regard to these differences, in step/message 1619, the SDN controller 1401 configures Function ID #0 to use MurmurhHash3-64 bits with CCNx object name as input. In step/message 1621, the controller 1401 sets a flow Fl matching CCN traffic leaving the domain with Apply-Action “HRC-Function” ID #0 to table 12 and two flows in Table 12 (of [19]), splitting the traffic between routers 3 and 4 based on metadata value.

In steps/messages 1623 and 1625, the SDN Controller 1401 performs similar operations for router 1409, as shown.

In this embodiment, after router 1409 receives the CCN content request from the other network 1500 (message 1526 in FIG. 16B) and matches it within the domain (step 1527), flow differs from that of FIGS. 15A and 15B in that router 1409 matches the request to flow entry F2 and calculates a hash value accordingly. Then, it proceeds with table 12 (of [19]) and finds that one of the flow entries in table 12 is a match (step 1629) and that the dictated action is to forward the request to router 1407 (which forwarding later occurs in step 1531). Flow then proceeds through steps/messages 1533, 1535, 1537, 1539, 1541, and 1543 as described in connection with FIGS. 15A and 15B. Then, after router 1403 receives the response to the content request from UE 1413 (message 1541) and determines to process the content response through the flow tables (step 1543), the next step is different than in the embodiment of FIGS. 15A and 15B. Particularly, similarly to step 1629 above, router 1403 matches the response and proceeds with table 12 (of [19]) and finds that one of the flow entries in table 12 is a match and that the dictated action is to forward the request to router 1407 (step 1645).

7.4 Hash Routing Control (HRC) in SDN—Other Alternate Embodiments

7.4.1 Application to other SDN Frameworks

While the two embodiments discussed above apply to OpenFlow, it is understood that similar solutions can be devised by enhancing other SDN southbound protocols (e.g., ForCES). The general idea is that the SDN controller specifies SDN flows (or rules) associated with a hash function, a descriptor to extract the input of the hash function, and a range of acceptable values for the output of the hash function.

7.5 Exemplary SDN Applications That May Use SDN Hash Routing Control

7.5.1 ICN Name Resolution System

Some ICN systems can be designed to use a hash-routing based name resolution system. Such systems can benefit from being implemented using SDN as a building block, as described in section 6. Section 7.2 detailed an enhancement to SDN enabling these ICN systems.

A simple north-bound API of such an ICN Name Resolution System (NRS) was described in section 6. Every ICN router can use it to join or leave the ICN NRS. The ICN NRS Application (within the SDN Controller) can then divide the hash value space between all ICN routers, and then configure the HRC-aware SDN devices to forward content requests and publish messages toward the appropriate ICN router using hash routing. Non HRC-aware SDN switch/routers can, for example, be configured to forward traffic to a given anycast IP address toward the closest HRC-aware SDN switch/router.

7.5.2 Overlay Distributed Hash Table

A second class of SDN application making use of the HRC feature described herein is a DHT application.

The north-bound API of such a DHT SDN application was described in section 6. It includes Join( ) Leave( ) TransferData( )and KeepAliveQ. These API actions can, for example, be implemented using a REST design using HTTP and JSON encoding. Any IP host can use this API to Join( ) a DHT network. The DHT SDN application can divide the hash value space between all DHT nodes, using a consistent hashing technique to minimize the fraction of the hash value space that gets remapped from one DHT node to another when a new node joins or leaves the network. The mapping between hash value space and DHT nodes can be entirely determined by the DHT SDN application once it knows which nodes belong to the DHT (and possibly taking into account the CPU/storage capacities of the nodes, which can be given in the Join( )message). Then, the DHT SDN application can use the method described in section 7.2 to configure the hash-routing flow entries in the SDN devices of the network.

7.5.3 Hash-Routing Based Peering

U.S. Provisional Patent Application No. 61/934,540, which is incorporated herein fully by reference, describes Hash-Routing based Peering (HRP), i.e., a method enabling networks to cooperate to divide a hash value space between them, which then enable the use of hash routing to cooperatively increase network efficiency. This cooperation could be enabled through a fully distributed mechanism or through a centralized, SDN-based mechanism using some of the concepts and embodiments disclosed in the present specification.

U.S. Provisional Patent Application No. 61/934,540 describes two north-bound APIs of such HRP SDN application, namely, an exterior routing API and an interior routing API. The exterior routing API includes:
POST /ehrp/peer-configuration, where the router informs the application of its peer configuration, including, for example, this peer's backhaul link capacity and caching capacity
POST /ehrp/peer-status, where the router updates its current load and other status information (current outage status, backhaul link load, cache load and hit ratio, load of any peer link)
POST /ehrp/peer-connectivity, where the router sets its willingness to route traffic to/from other interconnected peers, as well as the peer link capacity with these peers
At initialization time, the exterior “HRP” SDN Application (eHRP) obtains the list of available hash functions and input methods from the HRP Routers, which are SDN devices under the control of the controller this exterior HRP SDN Application runs on. eHRP selects a common hash function and ensures that all devices can use the proper input method (e.g., CCN content name can be used as input in the case where CCN is used).
Following a call to any of the above API functions, eHRP determines the proper allocation of hash value ranges between HRP routers (e.g., following an algorithm described in that aforementioned provisional patent application). At the end of that computation, eHRP knows how each HRP router should forward each portion of the hash value space. For each HRP router, eHRP defines flow entries (with hash function, input method, and range specification) to forward such traffic toward the proper peer HRP router. eHRP may use a south-bound API such as described in section 7.2 to configure the hash-routing flow entries in the HRP Router (which are SDN devices).

The interior routing API includes:
POST /ihrp/handled-key-ranges, where the router provides the application with the set of key-ranges that it wishes to receive from routers and UEs inside its own domain. Typically, these key-ranges are the ones that this router will need to forward towards HRP peers. Router A obtains this list from its internal state (which was built using exterior HRP routing).
After an initialization similar to the eHRP case above, the interior HRP SDN Application (iHRP) can process the handled-key-ranges API call. The actual implementation may depend on the topology of the network, especially on which SDN devices are HRC-aware and which devices are not. In one example, let us assume there is one HRC-aware SDN router/switch inside the network. Other SDN devices should then be configured to forward all content requests/responses through this device. iHRP configures hash-routing flows in this device to forward certain content request/responses through the border HRP router of this domain, while all other request/responses should be sent over the backhaul link.

7.5.4 Load Balancing in IP Network

As a fourth class of SDN application that may make use of the HRC feature in the present invention, consider an exemplary load balancing SDN application, (hereinafter LBS). LBS is deployed in a SDN domain that has some HRC-aware SDN devices. A client networking application uses LBS's API to set pools of caches, set traffic filters to match traffic that will be handled by the caches, and update load status for each cache (note that, alternatively, the caches may also update this information themselves, using the API). The northbound API shown in Table 13 below is an example of such an API and how this API can make use of the underlying HRC features described in this specification.

TABLE 13
Northbound API (some functions are informally named for
later reference in this document):

```
POST /lbs/pool/add
  Creates an empty pool, associated with rules to match a certain type
  of traffic, e.g., “all content requests/responses for content located
  outside of our local domain”
PUT /lbs/pool/<pool-id>
  Update the rules associated with the pool
GET / lbs/ pool/<pool-id>
  List the nodes placed in the pool (node IDs may be IP addresses,
  for example)
ActivatePool( ): POST / lbs/pool/<pool-id>/activate
DeactivatePool( ): POST / lbs/pool/<pool-id>/deactivate
AddNode( ): POST / lbs/pool/<pool-id>/add
  Add a node in a pool
DeleteNode( ): DELETE / lbs/pool/<pool-id>/<node-id>
  Remove a node from a pool
UpdateNodeStatus( ): POST / lbs/node/<node-id>/load
  Update the load status for a node
```

A call to ActivatePool could result in LBS configuring the non-HRC-aware part of the network to properly forward traffic toward one of the HRC-aware SDN devices. LBS divides the hash value space between all nodes configured in the pool. Then, HRC-aware SDN devices are configured with HRC-aware flow entries, directing matching packets toward the proper cache.

Subsequent calls to AddNodeQ,DeleteNode( )and UpdateNodeStatus( )will result in LBS recalculating the appropriate re-partition of the hash value space between caches, and reconfiguring HRC-aware SDN devices with the new or updated flow entries.

### 8 NETWORKS FOR IMPLEMENTATION

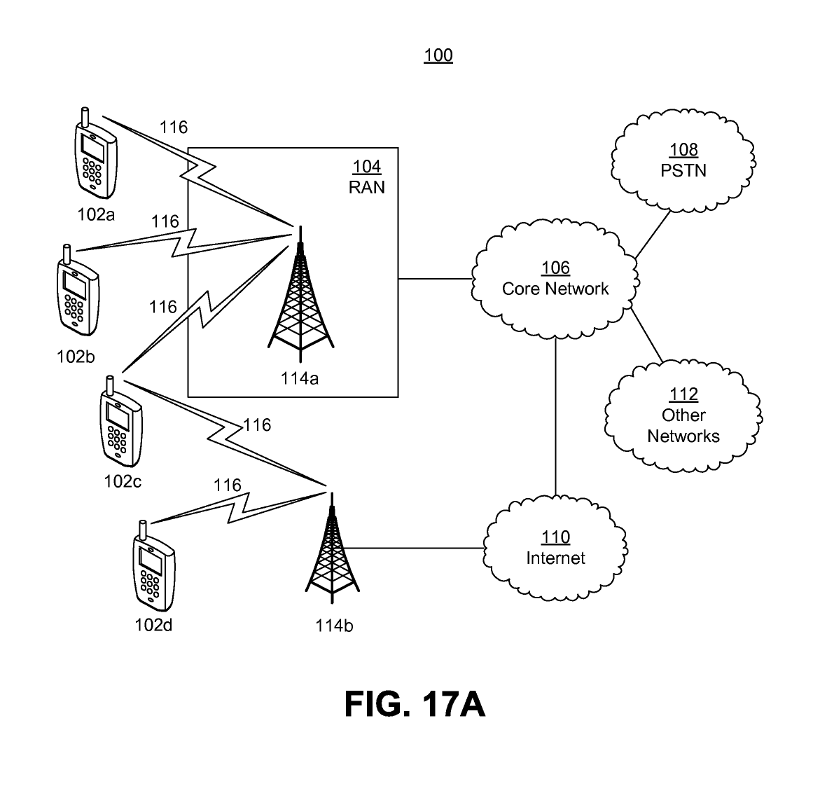

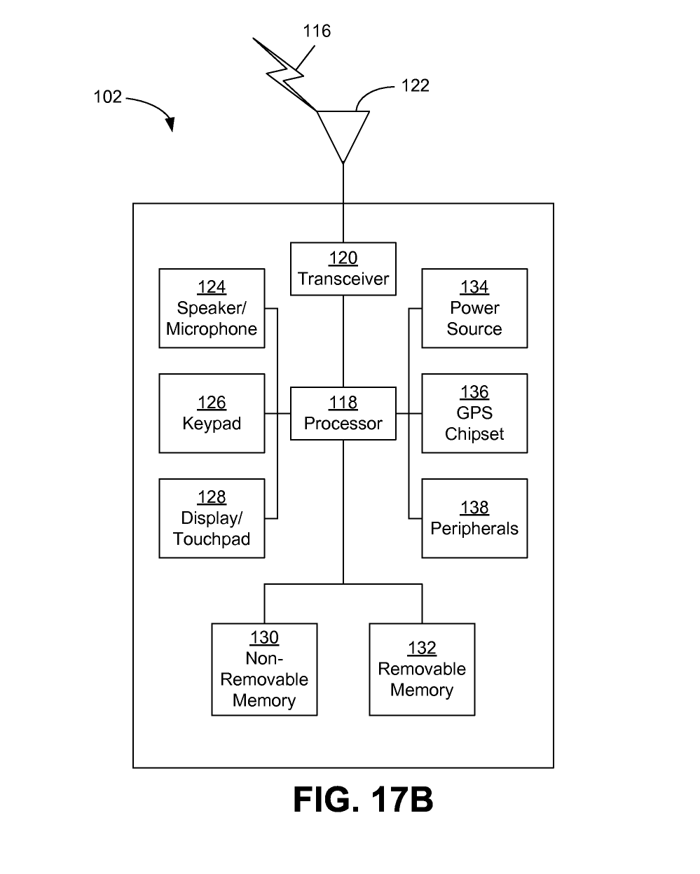

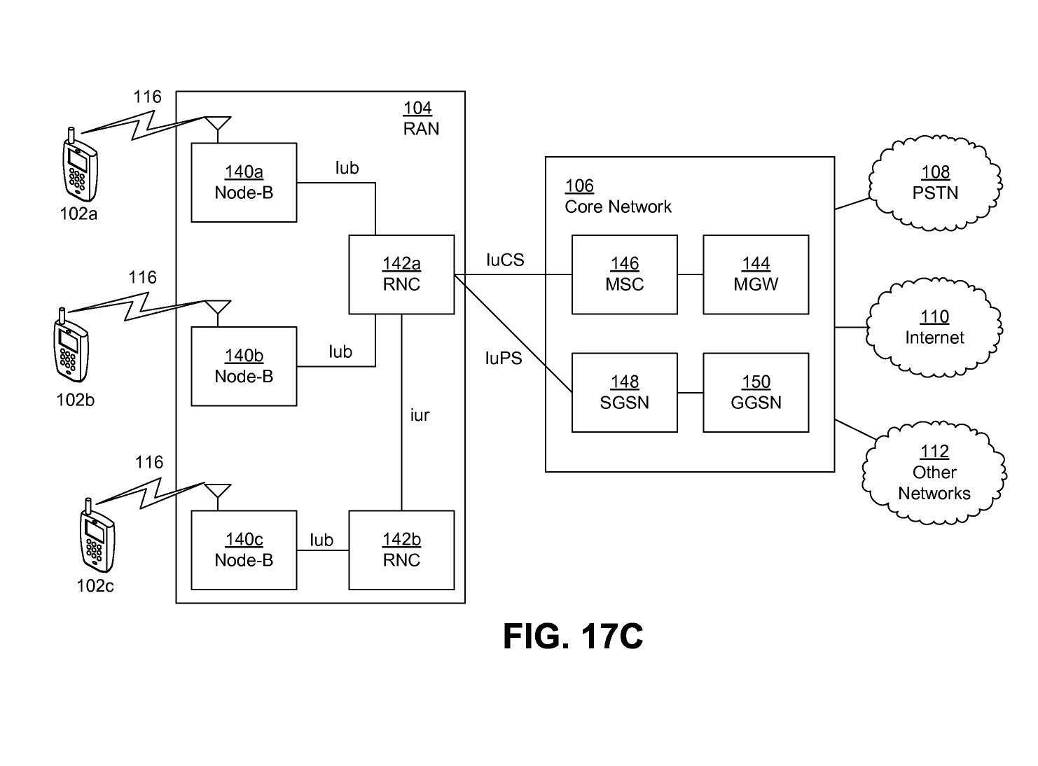

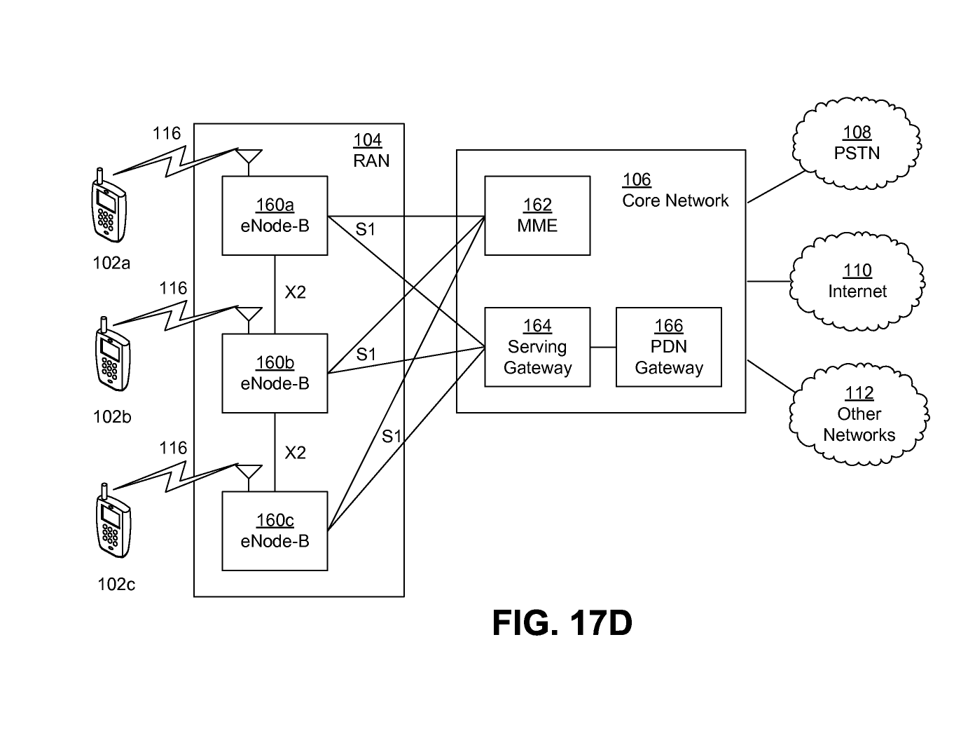

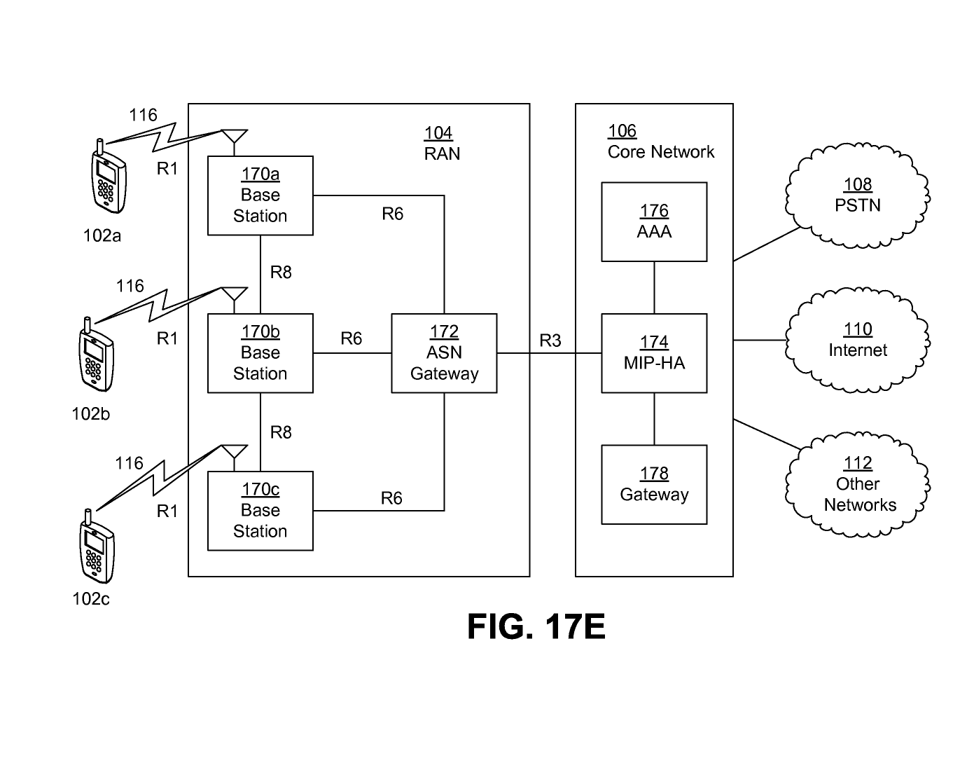

FIG. 17A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 17A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the b,Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA20001x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 17A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 17A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 17A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 17A may be configured to communicate with the base station 114a, which may employ a cellular-based radio technology, and with the base station 114b, which may employ an IEEE 802 radio technology.

FIG. 17B is a system diagram of an example WTRU 102. As shown in FIG. 17B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 17B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 17B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 17C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 17C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 17C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 17C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 17D is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 17D, the eNode-Bs 160a, 160b, 160c may communicate with one another over an X2 interface.

The core network 106 shown in FIG. 17D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring data planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 17E is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 17E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WTRUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WTRU 102a. The base stations 170a, 170b, 170c may also provide mobility management functions, such as handoff triggering, tunnel establishment, radio resource management, traffic classification, quality of service (QoS) policy enforcement, and the like. The ASN gateway 172 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 170a, 170b, 170c may be defined as an R8 reference point that includes protocols for facilitating WTRU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WTRUs 102a, 102b, 100c.

As shown in FIG. 17E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator.

The MIP-HA 174 may be responsible for IP address management, and may enable the WTRUs 102a, 102b, 102c to roam between different ASNs and/or different core networks. The MIP-HA 174 may provide the WTRUs 102a, 102b, 102c with access to packet-switched networks, such as the Internet 110, to facilitate communications between the WTRUs 102a, 102b, 102c and IP-enabled devices. The AAA server 176 may be responsible for user authentication and for supporting user services. The gateway 178 may facilitate interworking with other networks. For example, the gateway 178 may provide the WTRUs 102a, 102b, 102c with access to circuit-switched networks, such as the PSTN 108, to facilitate communications between the WTRUs 102a, 102b, 102c and traditional land-line communications devices. In addition, the gateway 178 may provide the WTRUs 102a, 102b, 102c with access to the networks 112, which may include other wired or wireless networks that are owned and/or operated by other service providers.

Although not shown in FIG. 17E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

### 9 EMBODIMENTS

In one embodiment, an apparatus is implemented for creating a Distributed Hash Table (DHT) among a plurality of DHT nodes in a Software Defined Networking (SDN) domain comprising: a DHT Control Plane (DHTCP) module adapted to manage a plurality of DHT nodes to maintain a DHT, the DHTCP comprising a processor adapted to: receive messages from DHT nodes indicating status of the DHT nodes, including joining and leaving the DHT; determine a range-based distribution among the DHT nodes of (key, value) pairs of a DHT as a function of the keys of the (key, value) pairs; and send configuration messages to the DHT nodes for configuring each DHT node to store at least one range of keys corresponding to ((key, value)) pairs of said DHT.

The preceding embodiment may further comprise wherein the processor is further adapted to: determine, based on the determined distribution, a DHT routing table for SDN switches for handling data plane DHT data requests in the domain; and send the DHT routing table to each DHT node.

One or more of the preceding embodiments may further comprise wherein the data plane data requests comprises at least one of DHT GET and DHT SET requests.

One or more of the preceding embodiments may further comprise wherein the SDN Controller further includes a processor adapted to: determine forwarding tables for said SDN switches in the domain based on said routing table received from said DHTCP; and send messages to said SDN switches in said domain for configuring said SDN switches with said forwarding tables.

One or more of the preceding embodiments may further comprise wherein the forwarding tables include rules for forwarding DHT GET/SET messages as a function of at least one field in the DHT GET/SET messages having a predetermined relationship to at least one DHT keys.

One or more of the preceding embodiments may further comprise wherein the forwarding tables include rules for forwarding DHT GET/SET messages based on at least one field in the DHT GET/SET messages being within a range corresponding to a set of DHT keys.

One or more of the preceding embodiments may further comprise wherein the forwarding tables include rules for forwarding DHT GET/SET messages based on at least one field in the DHT GET/SET messages strictly matching a value corresponding to a DHT key.

One or more of the preceding embodiments may further comprise wherein the forwarding tables further include rules for forwarding DHT GET/SET messages based on a DHT network ID.

One or more of the preceding embodiments may further comprise wherein the DHTCP is disposed within the SND controller.

One or more of the preceding embodiments may further comprise wherein the DHTCP is configured as a northbound Application Program Interface (API) client of the SDN controller.

One or more of the preceding embodiments may further comprise wherein the DHTCP includes an Application Program Interface (API) for communications between the DHTCP and the DHT nodes.

One or more of the preceding embodiments may further comprise wherein the communications between the SDN Controller and the SDN switches use OpenFlow communication protocol.

One or more of the preceding embodiments may further comprise wherein the SDN domain comprises an Information Centric Network (ICN).

One or more of the preceding embodiments may further comprise wherein the messages between the DHTCP and the DHT nodes are DHT control plane messages.

One or more of the preceding embodiments may further comprise wherein the messages between the DHTCP and the SDN Controller are DHT control plane messages.

One or more of the preceding embodiments may further comprise wherein the DHTCP comprises a network node distinct from the SDN Controller.

One or more of the preceding embodiments may further comprise wherein the DHTCP comprises part of the SDN Controller.

One or more of the preceding embodiments may further comprise wherein the DHTCP comprises a plurality of DHTCPs, each DHTCP adapted to manage a different plurality of DHT nodes to maintain a different DHT, and wherein the SDN Controller determines forwarding tables for said SDN switches in the domain based on a plurality of routing tables received from the plurality of DHTCPs.

In another embodiment, a method of processing Distributed Hash Table (DHT) routing requests in a Software Defined Networking (SDN) domain comprising a plurality of SDN switches interconnecting a plurality of DHT nodes, each DHT node containing a portion of a DHT comprises: receiving at a first one of the DHT nodes a Publish request corresponding to a content object, the Publish request including a (key, value) pair, where the key corresponds to a content ID and the value is the location where the content object is stored; if the key in the Publish request is in a portion of the DHT not contained at the first DHT node, the first DHT node forwarding the Publish request to a first one of the SDN switches; the first SDN switch including a forwarding table in which ranges of keys of (key, value) pairs are mapped to DHT nodes, and the first SDN switch matching the key from the Publish request with one of the key ranges in the forwarding table and forwarding the Publish request toward a second DHT node, the second DHT node being the DHT node to which the key of the ((key, value)) pair in the Publish request maps; and the second DHT node receiving the Publish request and storing the (key, value) pair found in the Publish request in its DHT portion.

The preceding embodiment may further comprise wherein the Publish request further includes a DHT data plane protocol header.

One or more of the preceding embodiments may further comprise the second DHT node sending a reply to the first DHT node.

One or more of the preceding embodiments may further comprise: a subscriber node sending the Publish request to the first DHT node; and the first DHT node forwarding the reply to the subscriber node.

In another embodiment, a method of processing Distributed Hash Table (DHT) routing requests in a Software Defined Networking (SDN) domain comprising a plurality of SDN switches interconnecting a plurality of DHT nodes, each DHT node containing a portion of a DHT comprises: receiving at a first one of the DHT nodes a Subscribe request for a content object, the Subscribe request including a key, where the key corresponds to a content ID; if the key in the Subscribe request does not match a key in the portion of the DHT of the first DHT node, the first DHT node forwarding the Subscribe request to a first one of the SDN switches; and the first SDN switch including a forwarding table in which ranges of keys corresponding to (key, value) pairs are mapped to DHT nodes, the first SDN switch matching the key from the Subscribe request with one of the key ranges in the forwarding table, and forwarding the Subscribe request toward a second DHT node, the second DHT node being the DHT node to which the key of the ((key, value)) pair in the Subscribe request maps.

The preceding embodiment may further comprise: the second DHT node selecting the (key, value) pair corresponding to the key in the Subscribe request and sending the value in the selected (key, value) pair to the first content router; responsive to receiving the value from the second DHT node, the first DHT node forwarding the Subscribe request toward a network node identified by the value.

One or more of the preceding embodiments may further comprise wherein the Subscribe request further includes a DHT data plane protocol header and the key is in the header.

In another embodiment, a method implemented in a Software Defined Networking (SDN) switch/router comprises: transmitting to an SDN controller a message including Hash Routing Control (HRC) capabilities of the switch/router; and receiving from the SDN controller a message including at least one hash routing descriptor indicating how the switch/router is to process routing requests.

The preceding embodiment may further comprise: wherein the at least one hash routing descriptor comprises at least one of (1) a first descriptor designating a method to be used by the switch /router to extract a hash function input from an incoming message, (2) a second descriptor designating how the hash function is to be calculated based on the hash function input to generate a hash value, and (3) a third descriptor indicating a range of the hash value within which the switch/router is to perform a specified action.

In another embodiment, a method implemented in a Software Defined Networking (SDN) switch/router comprises: maintaining a flow table for routing data packets in a SDN network; receiving from an SDN controller a flow table modification message defining a change to the flow table maintained at the switch/router, wherein the flow entry modification message further includes at least one of (1) an information element (IE) specifying a method for extracting hash function inputs from the data packets, (2) an IE specifying how a hash function is calculated from the hash function inputs, and (3) an IE specifying a range of hash function outputs to which the flow entry applies; and updating the flow table using the IEs in the flow entry modification message.

The preceding embodiment may further comprise: wherein the change defined in the flow table modification message comprises one of an additional flow entry in the flow table, a modification to a flow entry in the flow table, and a deletion of a flow entry in the flow table.

One or more of the preceding embodiments may further comprise wherein the flow table modification message further comprises an IE disclosing a number of hash routing descriptors contained in the flow table modification message.

One or more of the preceding embodiments may further comprise wherein the flow table includes flow entries including a plurality of match descriptors for matching fields in the data packets, said match descriptors including at least a hash routing match descriptor disclosing (1) a number of hash routing flows that the switch/router is capable of processing and (2) a hash routing match descriptor data structure.

One or more of the preceding embodiments may further comprise wherein the hash routing match descriptor data structure includes (1) a description of a hash function, (2) a description of an input method for the hash function, and (3) a range value disclosing a range of entries in a Distributed Hash Table (DHT) to which the corresponding flow entry applies.

One or more of the preceding embodiments may further comprise: receiving a data packet; comparing at least one matching field in the data packet with at least one of the match descriptors in a flow entry in the DHT to determine if the at least one matching field in the data packet matches at least one matching descriptor in the flow entry; and, if the at least one matching field of the data packet matches the at least one field of the flow entry, using the description of the input method of the flow entry to extract a set of hash input fields from the data message and select a particular hash function.

One or more of the preceding embodiments may further comprise: calculating a hash value using the particular hash function and set of hash input values; determining if the hash value is within the range value of the flow entry; and, if the hash value is within the range value of the flow entry, executing the instruction associated with the flow entry.

One or more of the preceding embodiments may further comprise: determining if a hash value for the particular hash function and set of hash input fields is stored in a cache; and, if a hash value for the particular hash function and set of hash input fields is stored in a cache; retrieving the cached hash value; determining if the cached hash value is within the range value of the flow entry; and, if the hash value is within the range value of the flow entry, executing instructions associated with the flow entry.

One or more of the preceding embodiments may further comprise: executing an action set associated with the instructions.

One or more of the preceding embodiments may further comprise: determining if the action set includes an entry point into another flow table; and, if the action set includes an entry point into another flow table, processing the data packet through the another flow table.

In another embodiment, a method implemented in a Software Defined Networking (SDN) controller for configuring an SDN network for Hash Routing Control (HRC) comprises: transmitting a features request message to a SDN switch/router requesting information disclosing hash routing control (HRC) features of the switch/router; and receiving in response to the features request a features reply message, the features response message including an HRC information element (IE) disclosing the HRC capabilities of the switch/router.

The preceding embodiments may further comprise wherein the features reply message discloses that the switch/router is HRC capable.

One or more of the preceding embodiments may further comprise: transmitting a flow table modification message to the switch/router disclosing a flow entry in a hash table maintained at the switch/router.

One or more of the preceding embodiments may further comprise wherein the flow entry modification message includes at least one of (1) an IE disclosing the number of hash routing descriptions entries included in the flow entry modification message, (2) an IE specifying a method for extracting hash function inputs from a data packet, (3) an IE specifying how a hash function is calculated from the hash function inputs, and (4) an IE specifying a range of hash function outputs to which the flow entry applies.

In another embodiment, a method implemented in a Software Defined Networking (SDN) switch/router comprises: maintaining a first flow table for routing data packets in a SDN network; maintaining a second flow table for routing the data packets according to a Hash Routing control (HRC); receiving from an SDN controller a flow table modification message defining a change to one of the first and second flow tables, the flow table modification message identifying a hash function and identifying a condition applicable to a hash value calculated using the hash function; and updating the first or second flow table according to the flow entry modification message.

The preceding embodiments may further comprise wherein the condition applicable to the hash value comprises a range of hash values.

One or more of the preceding embodiments may further comprise wherein the first flow table includes flow entries including a plurality of match descriptors for matching fields in the data packets and wherein the flow table modification message is for the first flow table and includes a first apply action instruction to execute a processing of the data packets received at the switch/router through the hash function using certain information elements from the data packets as inputs and forwarding to the second flow table on a condition that certain of the match descriptors match certain matching fields in the data packets.

One or more of the preceding embodiments may further comprise wherein the second table includes flow entries, each including a range match descriptor and a second apply action, the range match descriptor comprising a range of values, and the second apply action comprising an action to be performed on a condition that the hash value calculated using the hash function is within the range specified by the range match descriptor.

One or more of the preceding embodiments may further comprise wherein the first apply action instructions include: a function identifier identifying the hash function; and a table identifier identifying the second table.

One or more of the preceding embodiments may further comprise wherein the first apply action instruction further sets the result of the hash function as metadata.

One or more of the preceding embodiments may further comprise wherein the first apply action instruction further includes: a metadata mask identifying a part of a metadata field into which the result of the function is placed.

In another embodiment, a method implemented in a Software Defined Networking (SDN) controller, the method comprises: transmitting a flow table modification message to a SDN switch/router, wherein the flow table modification message defines a change to a flow table, identifies a hash function, and identifies a condition applicable to a hash value calculated using the hash function.

The preceding embodiment may further comprise wherein the flow table modification message includes an apply action instruction to execute a forwarding of a data packet received at the switch/router to a second flow table on a condition that certain of the match descriptors match certain matching fields in the data packet.

### 10 CONCLUSION

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed”, “computer executed” or “CPU executed”.

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (”ROM″)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶116, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WRTU), user equipment (UE), terminal, base station, Mobility Management Entity (MME) or Evolved Packet Core (EPC), or any host computer. The WRTU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### 11 REFERENCES

[1] Ahlgren, B.; Dannewitz, C.; Imbrenda, C.; Kutscher, D.; Ohlman, B., “A survey of information-centric networking,” Communications Magazine, IEEE , vol. 50, no. 7, pp. 26,36, July 2012, http://dx.doi.org/10.1109/MCOM.2012.6231276
[2] “CONET: a content centric inter-networking architecture” http://netgroup.uniroma2.it/Stefano_Salsano/papers/salsano-sigcomm-workshop-icn-11-submitted.pdf
[3] Liu H. et al., “A multi-level DHT routing framework with aggregation”, Proc. SIGCOMM ICN Workshop. ACM, 2012, http://conferences.sigcomm.org/sigcomm/2012/paper/icn/p43.pdf
[4] SAIL, “Final Netlnf Architecture”, SAIL Project Deliverable D-B.3, January 2013. http://www.sail-protect.eu/wp-content/uploads/2013/01/SAIL-DB3-v1.1-final-public.pdf
[5] M. D′Ambrosio, C. Dannewitz, H. Karl, and V. Vercellone. MDHT: A Hierarchical Name Resolution Service for Information-centric Networks. In ACM SIGCOMM Workshop on Information-Centric Networking (ICN 2011), Ottawa, Canada, August 2011
[6] Article on Amazon's Dynamo, Werner Vogels, http://www.allthingsdistributed.com/2007/10/amazons_dynamo.html
[7] OpenDHT http://opendht.org/ (the DHT itself is now unsupported, but code and associated research papers are still available)
[8] Bamboo DHT http://www.bamboo-dht.org (Bamboo is an open source DHT software that was used by OpenDHT)
[9] BitTorrent DHT search engine main page http://btdigg.org/about/index.html
[10] A Survey and Comparison of Peer-to-Peer Overlay Network Schemes (2005) by Eng Keong Lua, Jon Crowcroft, Marcelo Pias, Ravi Sharma, Steven Lim http://citeseer.ist.psu.edu/viewdoc/summary?doi=10.1.1.109.6124
[11] https://en.wikipedia.org/wiki/Distributedhashtable
[12] David Karger, Eric Lehman, Tom Leighton, Rina Panigrahy, Matthew Levine, and Daniel Lewin. 1997. Consistent hashing and random trees: Distributed caching protocols for relieving hot spots on the World Wide Web. In STOC ‘97: Proceedings of the 29th annual ACM symposium on theory of computing, 654-663, New York: ACM. http://thor.cs.ucsb.edu/˜ravenben/papers/coreos/k11+97.pdf
[13] Tarkoma, Sasu. (Book) Overlay Networks: Toward Information Networking. CRC Press, Taylor & Francis Group 2010. 260 s.
[14] C. Kim M. Caesar J. Rexford, “Floodless in SEATTLE: A Scalable Ethernet Architecture for Large Enterprise”, SIGCOMM'08, 2008. http://www.cs.princeton.edu/-chkim/Research/SEATTLE/seattle.pdf
[15] “The Northbound API-A Big Little Problem” Blog Entry on Northbound Interface (http://networkstatic.net/the-northbound-api-2/)
[16] IETF Draft “CDNI Request Routing with SDN”, July 2012, https://datatracker.ietforg/doc/draft-shin-cdni-request-routing-sdn/?includetext=1
[17] OpenFlow: Enabling Innovation in Campus Networks, March 14, 2008, http://www.openflow.org/documents/openflow-wp-latest.pdf
[18] OpenFlow Switch Specification, Version 1.3.0 (Wire Protocol 0x03), June 25, 2012, https://www.opennetworking. org/images/stories/downloads/specification/openflow-spec-v1.3.0.pdf
[19] Marc Mendonca, Bruno Nunes Astuto, Xuan Nam Nguyen, Katia Obraczka, Thierry Turletti “A Survey of Software-Defined Networking: Past, Present, and Future of Programmable Networks”, in Submission, 2013, http ://hal. inria. fr/docs/00/82/50/87/PDF/SDN_survey.pdf
[20] Xuan Nam Nguyen, “Software Defined Networking in Wireless Mesh Network”, MSc UBINET Thesis, INRIA, August 2012. http://inrg.cse.ucsc.edu/community/Publications? action=AttachFile&do=get&target=nam-ms.pdf
[21] “Software defined networking” https://www.opennetworking.org/[22] “OpenFlow,” http://www.openflow.org/[23] “OpenFlow specification version 1.1,” 2011. http://www.openflow.org/documents/openflow-spec-v1.1.0.pdf [24] “Google describes its OpenFlow network,” http ://www. eetimes.comlelectronics-news/43 711 79/Google-describes-its-OpenFlow-network, 2012.
[25] D. Syrivelis, G. Parisis, D. Trossen, P. Flegkas, V. Sourlas, T. Korakis, L. Tassiulas, Pursuing a Software-Defined Information-Centric Network, EWSDN 2012, IEEE, Darmstad Germany http://ieeexplore.ieee.org/xpl/articleDetails.jsp?tp=&arnumber=6385056
[26] N. Blefari-Melazzi, A. Detti, G. Mazza, G. Morabito, S. Salsano, L. “An OpenFlow-based Testbed for Information Centric Networking”, Future Network & Mobile Summit 2012, 4-6 Jul. 2012, Berlin, Germany, http://netgroup.uniroma2.it/Stefano_Salsano/papers/salsano-futint-mobsumm-12-openflow.pdf
[27] CONET Portal, section “CONET and Software Defined Networks/OpenFlow”, http://netgroup.uniroma2.it/twiki/bin/view/Netgroup/CoNet#AnchorConetSdn
[28] I. Carvalho, F. Faria, E. Cerqueira, A. Abelem., “ContentFlow: An Introductory Routing Proposal for Content Centric Networks using Openflow” API, 7th Think-Tank Meeting 2012. http://siti.ulusofona.pt/aigaion/index.php/attachments/single/361
[29] Abhishek Chanda, Cedric Westphal, “Content as a Network Primitive”, 2013, http://arxiv.org/pdf/1212.3341v1.pdf
[30] Abhishek Chanda, Cedric Westphal, Dipankar Raychaudhuri, “Content Based Traffic Engineering in Software Defined Information Centric Networks”, 2013, http://arxiv.org/pdf/1301.7517v1.pdf
[31] X. N. Nguyen, D. Saucez, T. Turletti, “Efficient caching in Content-Centric Networks using OpenFlow”, 2013, http://hal. inria.fr/docs/00/79/00/02/PDF/1569714051Efficientcaching_in_Content-Centric_Networks_using_OpenFlow.pdf [32] Xuan Nam Nguyen, “Software Defined Networking in Wireless Mesh Network”, MSc UBINET Thesis, INRIA, August 2012. http://inrg.cse.ucsc.edu/community/Publications?action=AttachFile&do=get&target=nam-ms.pdf
[33] Hyogi Jung, “C-flow: Content-oriented Networking over OpenFlow”, Open networking summit (ONS), Santa Clara, California, USA, April, 2012 http://www.opennetsummit org/pdf/snu.pdf
[34] T. Lakshman and D. Stiliadis, “High-speed policy-based packet forwarding using efficient multi-dimensional range matching,” ACM Computer Communication. Review, vol. 28, no. 4, pp. 203-214, October 1998.

1-29. (canceled)

30. A method implemented in a Software Defined Networking (SDN) switch/router comprising:
maintaining a flow table for routing data packets in a SDN network;
receiving from an SDN controller a flow table modification message defining a change to the flow table maintained at the switch/router, wherein the flow entry modification message further includes at least one of (1) an information element (IE) specifying a method for extracting hash function inputs from the data packets, (2) an IE specifying how a hash function is calculated from the hash function inputs, and (3) an IE specifying a range of hash function outputs to which the flow entry applies; and
updating the flow table using the IEs in the flow entry modification message.

31. The method of claim 30 wherein the change defined in the flow table modification message comprises one of an additional flow entry in the flow table, a modification to a flow entry in the flow table, and a deletion of a flow entry in the flow table.

32. The method of claim 30 wherein the flow table modification message further comprises an IE disclosing a number of hash routing descriptors contained in the flow table modification message.

33. The method of claim 32 wherein the flow table includes flow entries including a plurality of match descriptors for matching fields in the data packets, said match descriptors including at least a hash routing match descriptor disclosing (1) a number of hash routing flows that the switch/router is capable of processing and (2) a hash routing match descriptor data structure.

34. The method of claim 33 wherein the hash routing match descriptor data structure includes (1) a description of a hash function, (2) a description of an input method for the hash function, and (3) a range value disclosing a range of entries in a Distributed Hash Table (DHT) to which the corresponding flow entry applies.

35. The method of claim 34 further comprising:
receiving a data packet;
comparing at least one matching field in the data packet with at least one of the match descriptors in a flow entry in the DHT to determine if the at least one matching field in the data packet matches at least one matching descriptor in the flow entry; and
if the at least one matching field of the data packet matches the at least one field of the flow entry, using the description of the input method of the flow entry to extract a set of hash input fields from the data message and select a particular hash function.

36. The method of claim 35 further comprising:
calculating a hash value using the particular hash function and set of hash input values;
determining if the hash value is within the range value of the flow entry; and
if the hash value is within the range value of the flow entry, executing the instruction associated with the flow entry.

37. The method of claim 35 further comprising:
determining if a hash value for the particular hash function and set of hash input fields is stored in a cache; and
if a hash value for the particular hash function and set of hash input fields is stored in a cache;
retrieving the cached hash value;
determining if the cached hash value is within the range value of the flow entry; and
if the hash value is within the range value of the flow entry, executing instructions associated with the flow entry.

38. The method of claim 36 further comprising:
executing an action set associated with the instructions.

39. The method of claim 36 further comprising:
determining if the action set includes an entry point into another flow table; and
if the action set includes an entry point into another flow table, processing the data packet through the another flow table.

40. A method implemented in a Software Defined Networking (SDN) controller for configuring an SDN network for Hash Routing Control (HRC), the method comprising:
transmitting a features request message to a SDN switch/router requesting information disclosing hash routing control (HRC) features of the switch/router; and
receiving in response to the features request a features reply message, the features reply message including an HRC information element (IE) disclosing the HRC capabilities of the switch/router.

41. The method of claim 40 wherein the features reply message discloses that the switch/router is HRC capable.

42. The method of claim 40 further comprising:
transmitting a flow table modification message to the switch/router disclosing a flow entry in a hash table maintained at the switch/router.

43. The method of claim 42 wherein the flow entry modification message includes at least one of (1) an IE disclosing the number of hash routing descriptions entries included in the flow entry modification message, (2) an IE specifying a method for extracting hash function inputs from a data packet, (3) an IE specifying how a hash function is calculated from the hash function inputs, and (4) an IE specifying a range of hash function outputs to which the flow entry applies.

44. A method implemented in a Software Defined Networking (SDN) switch/router comprising:
maintaining a first flow table for routing data packets in a SDN network;
maintaining a second flow table for routing the data packets according to a Hash Routing control (HRC);
receiving from an SDN controller a flow table modification message defining a change to one of the first and second flow tables, the flow table modification message identifying a hash function and identifying a condition applicable to a hash value calculated using the hash function; and
updating the first or second flow table according to the flow entry modification message.

45. The method of claim 44 wherein the condition applicable to the hash value comprises a range of hash values.

46. The method of claim 44 wherein the first flow table includes flow entries including a plurality of match descriptors for matching fields in the data packets and wherein the flow table modification message is for the first flow table and includes a first apply action instruction to execute a processing of the data packets received at the switch/router through the hash function using certain information elements from the data packets as inputs and forwarding to the second flow table on a condition that certain of the match descriptors match certain matching fields in the data packets.

47. The method of claim 46 wherein the second table includes flow entries, each including a range match descriptor and a second apply action, the range match descriptor comprising a range of values, and the second apply action comprising an action to be performed on a condition that the hash value calculated using the hash function is within the range specified by the range match descriptor.

48. The method of claim 46 wherein the first apply action instructions include:
a function identifier identifying the hash function; and
a table identifier identifying the second table.

49. The method of claim 46 wherein the first apply action instruction further sets the result of the hash function as metadata.

50. The method of claim 49 wherein the first apply action instruction further includes:
a metadata mask identifying a part of a metadata field into which the result of the function is placed.

51-52. (canceled)
